(19) United States
(12) Patent Application Publication
(10) Pub. No.: US 2021/0245054 A1
(43) Pub. Date: Aug. 12, 2021

(54) Systems and Methods for Object Management

(71) Applicant: YISIA Games Ltd, Goyang City (KR)

(72) Inventors: Yisia Young Suk Lee, Goyang City (KR); Jang Soo Lee, Asan City (KR)

(73) Assignee: YISIA Games Ltd, Goyang City (KR)

(21) Appl. No.: 17/169,783

(22) Filed: Feb. 8, 2021

Related U.S. Application Data
(60) Provisional application No. 62/972,755, filed on Feb. 11, 2020.

(51) Int. Cl. A63F 13/577; G06F 3/0484; G06F 3/0486; A63F 13/53

(52) U.S. Cl. CPC A63F 13/577; A63F 13/53; G06F 3/0486; G06F 3/04842

(57) ABSTRACT

A method for providing a game or test application can include causing a workplace to be displayed on an interface, the workplace comprising a plurality of field objects and a plurality of mechanic objects, wherein each of the mechanic objects is positioned within a field object; causing a plurality of controllable objects to be displayed on the interface; receiving a command to move one of the controllable objects to a position that overlays at least a portion of the plurality of field objects; converting the overlaid portion of the plurality of field objects to an active region; identifying a mechanic object contained within the active region; and in response to identifying the mechanic object contained within the active region, running a mechanic object behavior on the mechanic object within the active region.

### CROSS-REFERENCE TO RELATED APPLICATIONS

This application claims priority to U.S. Provisional Application No. 62/972,755, filed on Feb. 11, 2020, which is herein incorporated by reference in its entirety.

### BACKGROUND OF THE DISCLOSURE

The brains of multicellular eukaryotic organisms (e.g., humans and other animals) utilize cognitive processes that match information retrieved from stimuli with information retrieved from memory. Based on this cognition, humans (and animals to an extent) can partake in various games or puzzles that require a person to remember a set of rules or pre-programmed actions.

In conventional cognitive testing, a user has to select an answer from the options listed for a given question. In other types of testing, the user can issue a command directly on an object (e.g., something displayed on an interface whose behavior is governed by a user's moves or actions and the game's response to them) to change the position, behavior, or nature of the object. The user can also delete the object.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a block diagram of an example system that can implement object management techniques, according to some embodiments of the present disclosure.

FIG. 2 is a system diagram with example devices that can implement object management techniques, according to some embodiments of the present disclosure.

FIG. 3 shows example input devices that can be used within the systems of FIGS. 1-2, according to some embodiments of the present disclosure.

FIG. 4 is a flow diagram showing example processing for object management, according to some embodiments of the present disclosure.

FIGS. 5A, 6A, and 7A are flow diagrams showing examples of object behaviors, according to some embodiments of the present disclosure. FIGS. 5B, 6B, and 7B show example parameter tables that can be used within FIGS. 5A, 6A, and 7A, respectively, according to some embodiments of the present disclosure.

FIG. 8 shows an example interface displayed to a user, according to some embodiments of the present disclosure.

FIG. 9 shows example controllable objects that a user can control to manipulate mechanic objects, according to some embodiments of the present disclosure.

FIG. 10 is an example controllable object, according to some embodiments of the present disclosure.

FIG. 11 is an example field object, according to some embodiments of the present disclosure.

FIG. 12 is an example active field object, according to some embodiments of the present disclosure.

FIG. 13 shows an example of a controllable object being manipulated by a user, according to some embodiments of the present disclosure.

FIG. 14 shows a controllable object overlaying a field object, according to some embodiments of the present disclosure.

FIG. 15 shows an example active field object resulting from the manipulation of FIG. 13, according to some embodiments of the present disclosure.

FIGS. 16-18 show example types of mechanic objects, according to some embodiments of the present disclosure.

FIGS. 19-27 show examples of controllable objects being manipulated by a user, according to some embodiments of the present disclosure.

FIGS. 28-38 show example behavior of a mechanic object, according to some embodiments of the present disclosure.

FIGS. 39-43 show additional example behavior of a mechanic object, according to some embodiments of the present disclosure.

FIGS. 44-51 show additional example behavior of a mechanic object, according to some embodiments of the present disclosure.

FIG. 52 shows an example interface displayed to a user, according to some embodiments of the present disclosure.

FIGS. 53-69 show example controllable objects, according to some embodiments of the present disclosure.

FIGS. 70-71 show example interfaces displayed to a user, according to some embodiments of the present disclosure.

FIG. 72 shows another example interface displayed to a user, according to some embodiments of the present disclosure.

FIGS. 73-82 show additional example controllable objects, according to some embodiments of the present disclosure.

FIGS. 83-88 show additional example interfaces displayed to a user, according to some embodiments of the present disclosure.

FIG. 89 shows an example mission or goal that can be displayed to a user prior to beginning a session, according to some embodiments of the present disclosure.

FIGS. 90-91 show example interfaces that can be displayed to a user upon completion of a session, according to some embodiments of the present disclosure.

FIGS. 92-107 show an example of a failed session of a user playing an object management game, according to some embodiments of the present disclosure.

FIGS. 108-124 show an example of a successful session of a user playing an object management game, according to some embodiments of the present disclosure.

FIG. 125 is an example server device that can be used within the system of FIG. 1 according to an embodiment of the present disclosure.

FIG. 126 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DETAILED DESCRIPTION OF SEVERAL EMBODIMENTS

Embodiments of the present disclosure relate to systems and methods that allow a user to manage and manipulate various data objects via a user interface. The disclosed object management techniques may be used to evaluate and/or improve a user's memory, cognitive abilities, abstract and logical reasoning, sequential reasoning, and/or spatial ability through a user-selectable application (e.g., a neuropsychological test). The application can allow a user to remember and apply pre-programmed behaviors to objects via a display to achieve a certain, pre-specified goal. In some embodiments, the disclosed principles can provide a methodology in which a user can effect change in an environment of a specific area on a display to manipulate objects; the user can make various manipulations to achieve a goal. The result of the test can be scored and can reflect the user's predictive ability to infer the effects of their manipulations. In some embodiments, the disclosed principles can be implemented as, but are not limited to, a video game, a computer-assisted testing device, a personal memory test, a training device, a mathematical visualization device, or a simulation device. In some embodiments, the game, test or simulation application can be run as an application on a mobile device (e.g., an iOS or Android app); in other embodiments, the application can be run in a browser and the processing can be performed by a server remote from the device running the browser.

In general, the game or test application of the present disclosure will involve a workplace that is displayed on a user interface that includes field objects, controllable objects, and mechanic objects. A plurality of field objects will be displayed to a user in a grid-like or similar fashion (e.g., a grid of rectangles where each rectangle is a field object). Controllable objects can be controlled by a user (e.g., clicked and dragged) and can have a variety of shapes or permutations (e.g., similar to Tetris) made up of units of area that are the same as a field object. For example, one controllable object can simply be a rectangle that a user can click and drag onto the grid of field objects such that it overlays a particular field object. Within the field object grid in the workplace are mechanic objects, which can be represented by various icons (e.g., musical notes throughout the present disclosure, although this is not limiting) that are contained within specific field objects. For example, an icon may be contained within a rectangle of the grid. Mechanic objects exhibit various behaviors (e.g., moving horizontally, moving vertically, colliding with others, etc.) based on a user activating the field object that contains the mechanic object. A user can “activate” the field object or convert it into an active field object by moving a controllable object onto said field object.

The goal or mission, which would be displayed to the user prior to beginning a session, can define what a user needs to do to the various mechanic objects in the field object grid in order to win. The user will be provided with a limited number of controllable objects and must manipulate the mechanic objects by moving controllable objects onto the grid, which would activate the corresponding field objects and cause the mechanic objects to behave in certain pre-defined ways. There can be various types of mechanic objects. For example, an immobile mechanic object may not move but may exhibit certain behavior when another type of mechanic object collides with it. A horizontal mechanic object may only move horizontally once its corresponding field objects become active. A vertical mechanic object may only move vertically once its corresponding field objects become active. A user can remember these pre-defined behavioral patterns and use them to manipulate the mechanic objects in order to reach the mission. If the user achieves the goal or mission without running out of available controllable objects, the user wins. Otherwise, the user loses.

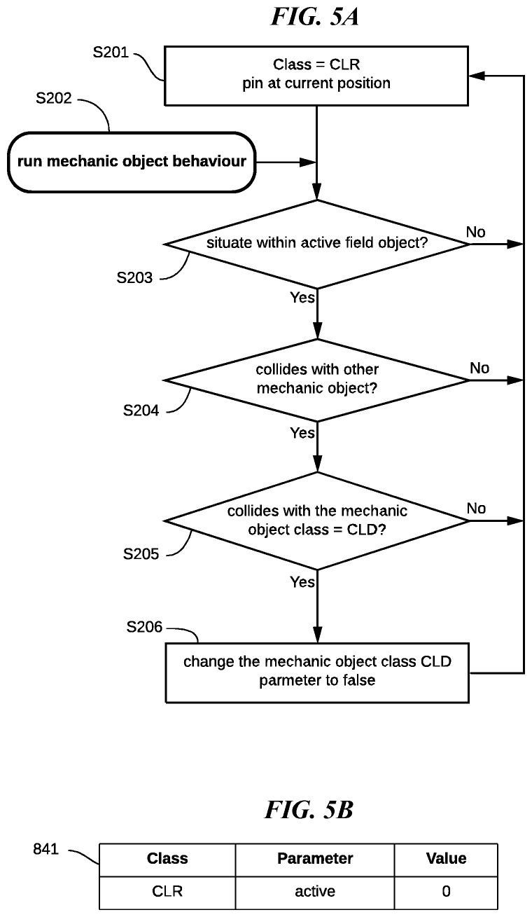

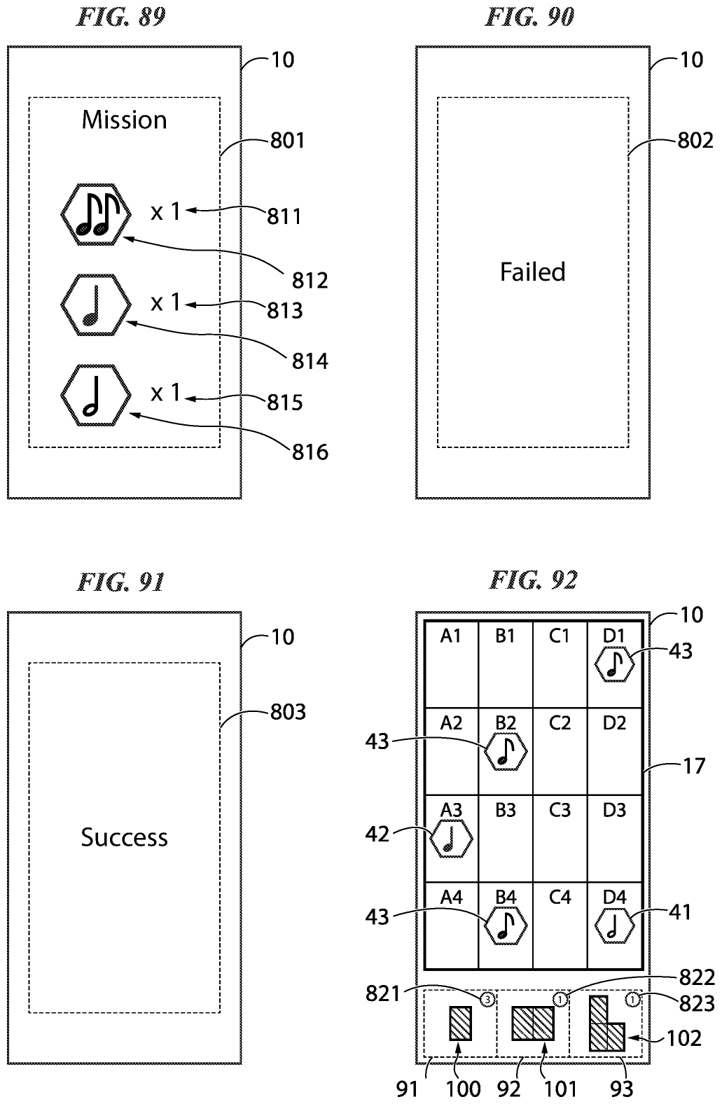

An example of an interface 10 is shown in FIG. 92, which can be displayed on a user device such as a laptop or smartphone. The interface 10 can include a field object grid 17; the object grid 17 includes a plurality of field objects A1-A4, B1-B4, C1-C4, and D1-D4. A portion of the field objects include mechanic objects 41-43 of different types. The interface 10 can also include one or more controllable objects 100-102; a user can move and place a controllable object onto the field object grid 17 such that it aligns with some of the field objects. For example, the manipulation can be done by clicking and dragging with a cursor or via touchscreen or by issuing a keyboard command. Once a controllable object is placed on a field object, the field objects that are overlaid by the controllable object become active field objects. If an active field object has a mechanic object (e.g., 41, 42, or 43) within it, the mechanic object will behave in certain ways according to the type of mechanic object; the different behaviors and types of mechanic objects will be discussed in relation to FIGS. 5-7. For example, mechanic objects 41, 42, and 43 may behave differently if they reside within an active field objects. The pre-preprogrammed behavior can also define what happens when there is a collision with another mechanic object. The user can then utilize the various controllable objects 100-102 provided to them to manipulate the mechanic objects 41-43 within the field object grid 17 to achieve a certain pre-defined goal or mission which is displayed to the user before beginning a session, such as the mission defined in FIG. 89.

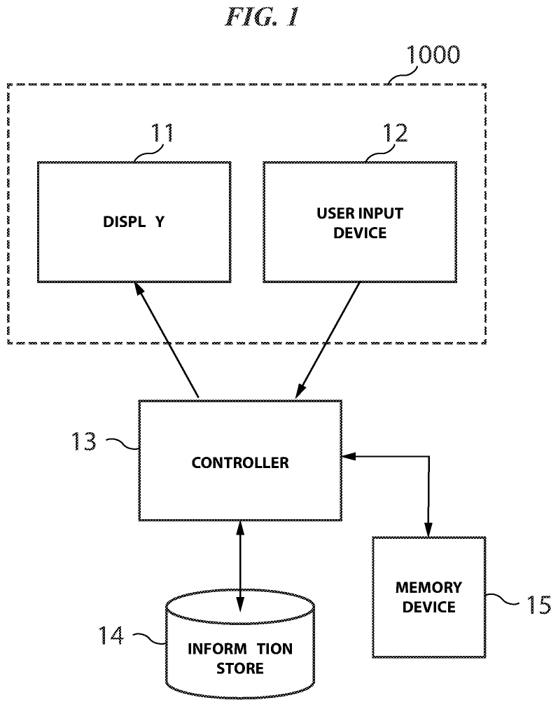

FIG. 1 is a block diagram of an example system that can implement object management techniques, according to some embodiments of the present disclosure. The system can include a user interaction system 1000, which includes a display 11 and a user input device 12. The display 11 can display various interfaces associated with the disclosed principles, such as goals/missions for testing and gaming and relevant interfaces for a user to participate in the test or game, such as the available controllable objects, the mechanic objects, and a field object grid. The user input device 12 can include devices such as a mouse or a touchscreen. The system can also include a controller 13 that can control the various interactions and components to be displayed on display 11. The controller 13 can access an information store 14 and a memory device 15. The memory device 15 can include various software and/or computer readable code for configuring a computing device to implement the disclosed object manipulation techniques. In some embodiments, the memory device 15 can comprise one or more of a CD rom, hard disk, or programmable memory device.

FIG. 2 is a system diagram with example devices that can implement object management techniques, according to some embodiments of the present disclosure. The system can include a server 16 communicably coupled via the internet to a computer 20 and a mobile device 21. In some embodiments, the server can utilize one or more of HTML docs, DHTML, XML, RSS, Java, streaming software, etc. In some embodiments, the computer 20 can include various computing apparatuses such as a personal computer, computer assisted testing devices, a connected TV, a game console, an entertainment machine, a digital media player, etc. In some embodiments, the mobile device 21 can include various devices such as PDAs, calculators, handheld computers, portable media players, handheld electronic game devices, mobile phones, tablet PCs, GPS receivers, etc.

In some embodiments, the internet can also include other types of communication and/or networking systems such as one or more wide areas networks (WANs), metropolitan area networks (MANs), local area networks (LANs), personal area networks (PANs), or any combination of these networks. The system can also include a combination of one or more types of networks, such as Internet, intranet, Ethernet, twisted-pair, coaxial cable, fiber optic, cellular, satellite, IEEE 801.11, terrestrial, and/or other types of wired or wireless networks or can use standard communication technologies and/or protocols.

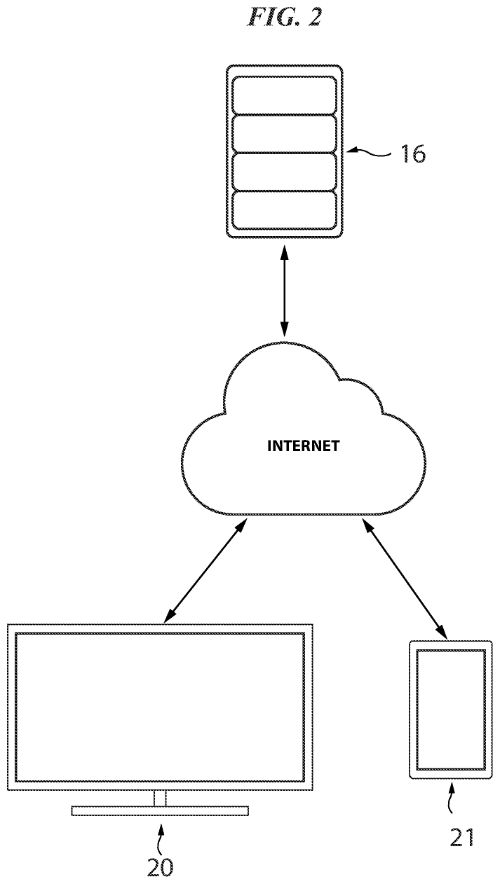

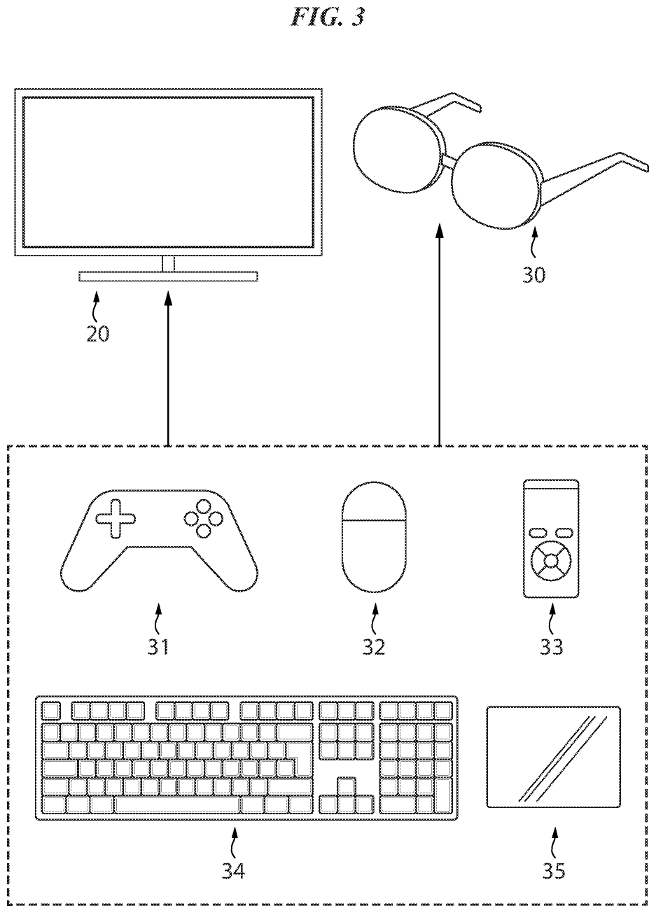

FIG. 3 shows example input devices that can be used within the systems of FIGS. 1-2, according to some embodiments of the present disclosure. For example, computer 20 can be connected to and receive inputs from at least one of a wearable computing device 30, a game controller 31, a mouse 32, a remote controller 33, a keyboard 34, and a trackpad 35. In some embodiments, the wearable computing device 30 can include devices such as a virtual reality headset, an optical head-mounted display, a smartwatch, etc.

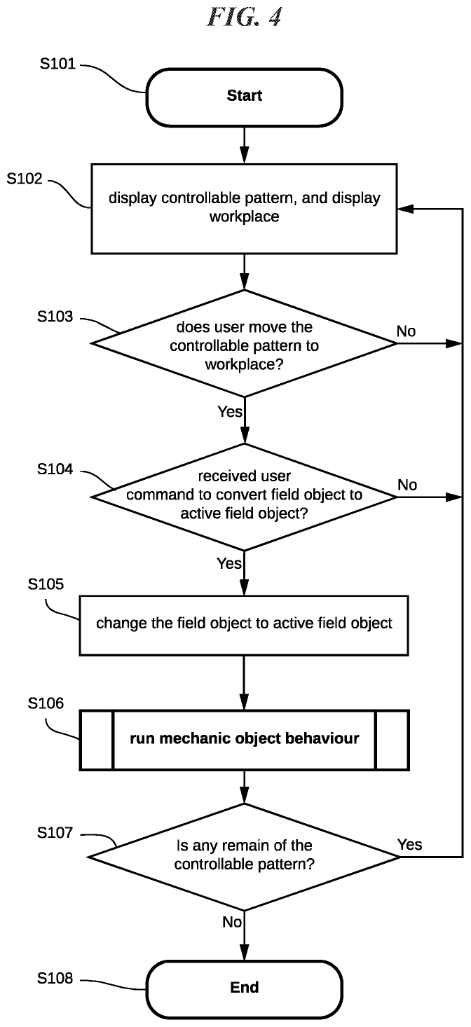

FIG. 4 is a flow diagram showing example processing for object management, according to some embodiments of the present disclosure. The process of FIG. 4 can describe how a user can interact with an object management system (e.g., FIGS. 1 and 2) and participate in a test or game. In some embodiments, the process of FIG. 4 can be referred to as a game or test “session” as described herein. The session begins at block S101. In some embodiments, initiating a session can also include server 16 causing a mission statement to be displayed on a mobile device 21. At block S102, a mobile device 21 can display a workplace (e.g., a field object grid) and one or more controllable objects available to the user for the session. At block S103, the server 16 determines whether the user has moved a controllable object to the field object grid. If the user has not moved a controllable object, processing returns to block S102 and the server 16 continues to display the field object grid and available controllable objects available to the user. If the user has moved a controllable object onto the field object grid, processing proceeds to S104.

At block S104, the server 16 determines whether a user command to convert the necessary field objects (e.g., the field objects overlaid by the moved controllable object) to active field objects has been received. If the user command has not been received, processing returns to block S102 and the server 16 continues to display the field object grid and available controllable objects available to the user. If the user command has been received, processing continues to block S105. At block S105, the server 16 changes the necessary field objects to active field objects. At block S106, server 16 runs mechanic object behavior on any mechanic objects that are now within active field objects. In some embodiments, this can include various behaviors such as combining, moving, or removing mechanic objects; additional details with respect to mechanic object behavior are described in relation to FIGS. 5-7. After the mechanic object behavior has been run by the server 16, processing can proceed to block S107. At block S107, the server 16 determines if there are any remaining controllable objects available to the user to place. For example, the user may have originally been provided with five mechanic objects; the server 16 would determine if any of these five controllable objects have not been placed. If the server 16 determines that there are still available controllable objects to play, processing returns to block S102 and the server 16 continues to display the field object grid and available controllable objects available to the user. If the server 16 determines that there are no more controllable objects to play (e.g., the user is out of moves and can no longer manipulate the mechanic objects in the field object grid), processing continues to block S108 and the game session ends.

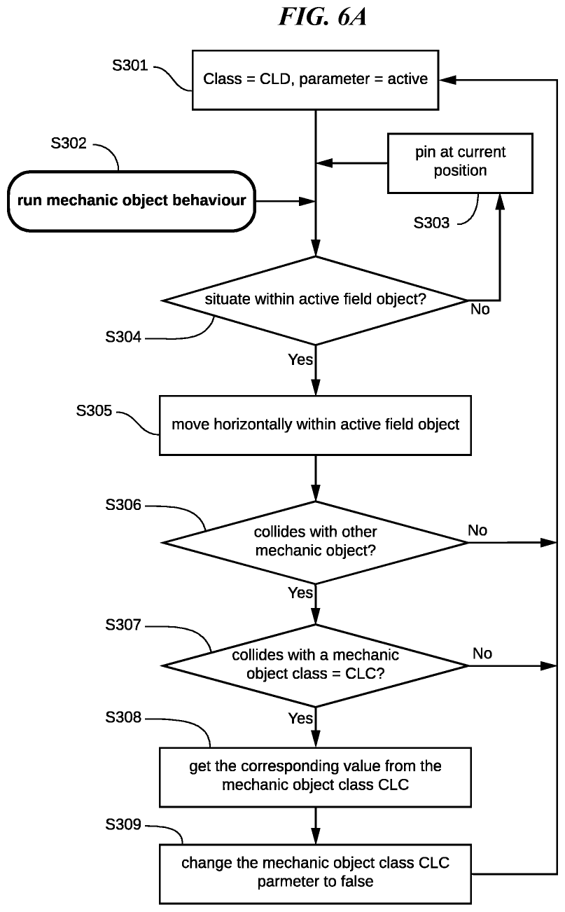

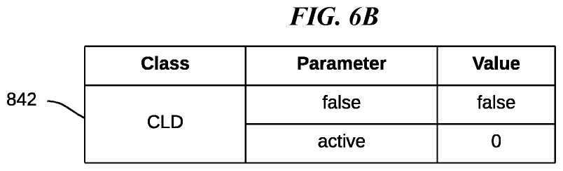

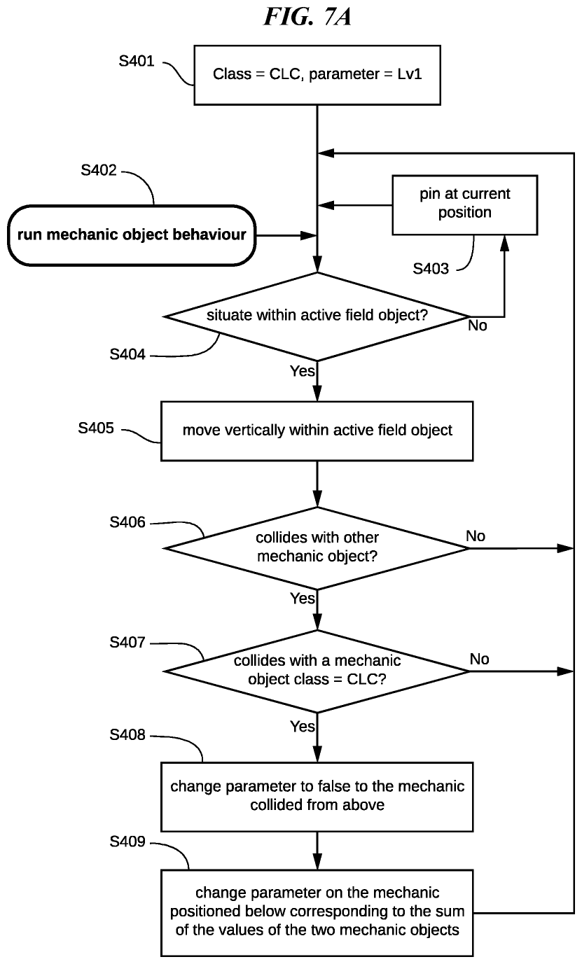

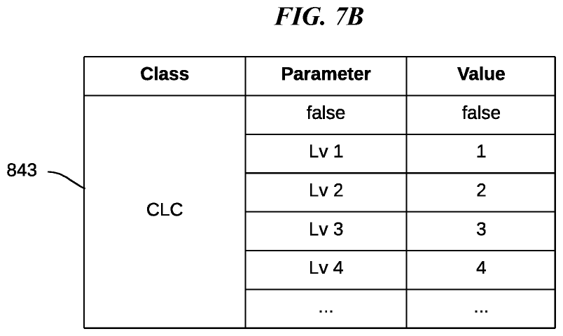

FIGS. 5-7 are flow diagrams showing examples of object behaviors, according to some embodiments of the present disclosure. As discussed above, there can be various types of mechanic objects that behave in different ways. Mechanic object types can include immobile mechanic objects, horizontal mechanic objects, and vertical mechanic objects and be identified by object classes. As described herein, a “CLR” class corresponds to an immobile mechanic object, a “CLD” class corresponds to a horizontal mechanic object, and a “CLC” class corresponds to a vertical mechanic object. In addition, each type of mechanic object has an associated parameter table. For example, FIG. 5B shows a parameter table 841 for an immobile mechanic object (CLR). The only parameter is “active”, and the only parameter value is 0. FIG. 6B shows a parameter table 842 for a horizontal mechanic object (CLD). The parameter can either be “false” or “active”. When the parameter is active, the parameter value is 0. When the parameter is false, the parameter value is also false, and the horizontal mechanic object disappears from the display. FIG. 7B shows a parameter table 843 for a vertical mechanic object (CLC). The parameter can be false, level 1, level 2, etc. The associated parameter value is either false (vertical mechanic object disappears) or the corresponding number is displayed. Note, object behavior may not necessarily include collisions and that the behaviors of FIGS. 5-7 is not limiting. In some embodiments, object behavior that includes movement (e.g., horizontal, vertical, diagonal, or any combination thereof) may not include collisions. For example, after a mechanic object moves within an active field region and enters the same field object as another mechanic object, there may be no collision behavior and the two mechanic objects can coexist in the same field object. In some embodiments, this “non-collision” feature can be pre-programmed for an additional type of mechanic object, such as a non-collision object.

In particular, FIG. 5A is a flow diagram showing object behavior for an immobile mechanic object. At block S201, the server 16 determines the class of the mechanic object and, if the class is CLR, then the immobile mechanic object is pinned at its current position (i.e., the current field object in which it is residing). At block S202, the server 16 begins to run mechanic object behavior in response to field objects becoming active field objects, as described in FIG. 4. At block S203, the server 16 determines whether the immobile mechanic object is situated within an active field object. If the immobile mechanic object is not situated within an active field object, processing returns to block S201 and the server 16 continues to pin the immobile mechanic object at its current position. If the immobile mechanic object is situated within an active field object, processing proceeds to block S204. At block S204, the server 16 determines if the immobile mechanic object collides with another mechanic object. A collision can occur with any other type of mechanic object and that a collision may be the result of the movement of any mechanic objects. For example, a horizontal mechanic object may have moved horizontally and collided with the immobile mechanic object. If the server 16 determines that there is not a collision, processing returns to block S201 and the server 16 continues to pin the immobile mechanic object at its current position. If the server 16 determines that there is a collision, processing proceeds to block S205.

At block S205, the server 16 can analyze the object class of the mechanic object that collided with the immobile mechanic object. If the server 16 determines that the colliding mechanic object is not a CLD class (not a horizontal mechanic object), processing returns to block S201 and the server 16 continues to pin the immobile mechanic object at its current position. If the server 16 determines that the colliding mechanic object is an CLD class, processing proceeds to block S206. At block S206, server 16 changes the object class of the horizontal mechanic object to “false” (see FIG. 6B), which causes the horizontal mechanic object to disappear and no longer be displayed to the user. Processing then returns to block S201 and the server 16 continues to pin the immobile mechanic object at its current position.

FIG. 6A is a flow diagram showing object behavior for a horizontal mechanic object. At block S301, the server 16 determines that the class of the mechanic object is CLD and the parameter value is set to active. At block S302, the server 16 begins to run mechanic object behavior in response to field objects becoming active field objects, as described in FIG. 4. At block S304, the server 16 determines whether the horizontal mechanic object is situated within an active field object. If the horizontal mechanic object is not situated within an active field object, processing proceeds to block S303 and the server 16 pins the horizontal mechanic object at its current position. If the horizontal mechanic object is situated within an active field object, processing proceeds to block S305. At block S305, the server 16 causes the horizontal mechanic object to move horizontally within the active field object. The horizontal movement can operate in a variety of formats. For example, if three horizontally consecutive field objects become active and one of the field objects contains a horizontal mechanic object, the horizontal mechanic object will move horizontally back and forth across the three consecutive active field objects. In other embodiments, the horizontal movement can move left to right once until the mechanic object reaches the end of the active field region, can move right to left until the mechanic object reaches the end of the active field region, can perform a single roundtrip right-to-left, can perform a single roundtrip left-to-right, or can perform multiple roundtrips in either direction. In some embodiments, it is also possible for mechanic object behavior to include both horizontal and vertical movement, similar to the L-shape movement pattern of a knight in chess, or diagonal movement.

At block S306, the server 16 determines if the horizontal mechanic object collides with another mechanic object. If the server 16 determines that there is not a collision, processing returns to block S301 and repeats; in other words, the horizontal mechanic object continues to move back and forth within the relevant active field as long as there are no collisions. If the server 16 determines that there is a collision, processing proceeds to block S307. At block S307, the server 16 can analyze the object class of the mechanic object that collided with the horizontal mechanic object. If the server 16 determines that the colliding mechanic object is not a CLC class (not a vertical mechanic object), processing returns to block S301 and repeats. If the server 16 determines that the colliding mechanic object is a CLC class (e.g., a vertical mechanic object), processing proceeds to block S308. At block S308, the server 16 obtains the corresponding parameter value from the vertical mechanic object, which can be used for computations in various applications (see “Alternate Embodiments”). At block S309, the server 16 changes the parameter of the vertical mechanic object to false and the vertical mechanic object disappears from the user's display. From here, processing can return to block S301.

FIG. 7A is a flow diagram showing object behavior for a vertical mechanic object. At block S401, the server 16 determines that the class of the mechanic object is CLC and the parameter value is at level 1, although level 1 is not required. At block S402, the server 16 begins to run mechanic object behavior in response to field objects becoming active field objects, as described in FIG. 4. At block S404, the server determines whether the vertical mechanic object is situated within an active field object. If the vertical mechanic object is not situated within an active field object, processing proceeds to block S403 and the server 16 pins the vertical mechanic object at its current position. If the vertical mechanic object is situated within an active field object, processing proceeds to block S405. At block S405, the server 16 causes the vertical mechanic object to move vertically within the active field object. The vertical movement can be performed in a variety of formats. For example, if three vertically consecutive field objects become active and one of the field objects contains a vertical mechanic object, the vertical mechanic object will move vertically until reach to the last of the three consecutive active field objects. In other embodiments, the vertical movement can move up to down once until the mechanic object reaches the end of the active field region, can move down to up until the mechanic object reaches the end of the active field region, can perform a single roundtrip up-to-down, can perform a single roundtrip down-to-up, or can perform multiple roundtrips in either direction. In some embodiments, it is also possible for mechanic object behavior to include both horizontal and vertical movement, similar to the L-shape movement pattern of a knight in chess, or diagonal movement.

At block S406, the server determines if the vertical mechanic object collides with another mechanic object. If the server 16 determines that there is not a collision, processing returns to block S401 and repeats; in other words, the vertical mechanic object is pinned at its current location. If the server 16 determines that there is a collision, processing proceeds to block S407. At block S407, the server 16 can analyze the object class of the mechanic object that collided with the vertical mechanic object. If the server 16 determines that the colliding mechanic object is not a CLC class (not a vertical mechanic object, processing returns to block S401 and repeats. If the server 16 determines that the colliding mechanic object is a CLC class (e.g., a vertical mechanic object), processing proceeds to block S408. At block S408, the server 16 changes the parameter of the vertical mechanic object that came from above to false, which makes it disappear from the user's display. At block S409, server 16 changes the parameter on the vertical mechanic object that came from below to the sum of the values of the two colliding mechanic objects. From here, processing can return to block S401.

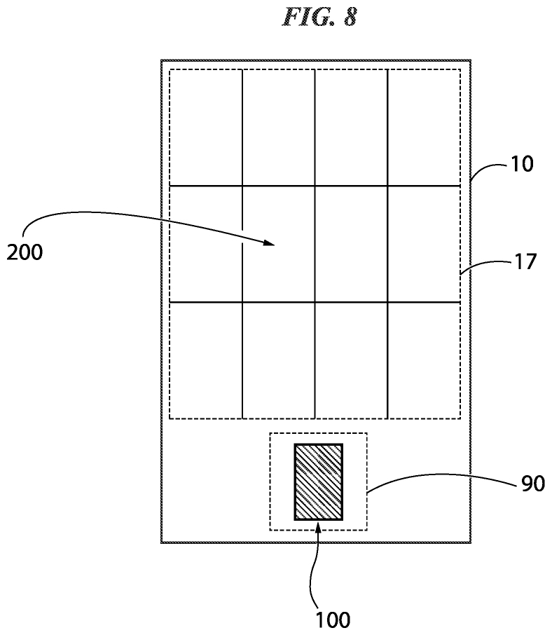

FIG. 8 shows an example interface 10 displayed to a user, according to some embodiments of the present disclosure. The interface 10 can be displayed on a variety of platforms such as computer 20 or mobile device 21. The interface 10 includes a controllable object 100 and a field object grid 17. The field object grid 17 can include a rectangular pattern 200 of field objects (also referred to herein singularly as “field object 200”), although this is not a limiting example and other arrangements are possible. In addition, a controllable object 100 can include a surrounding selectable region 90. A user can manipulate the controllable object 100 by clicking anywhere within the selectable region 90 and dragging the controllable object 100 for placement on the rectangular pattern 200.

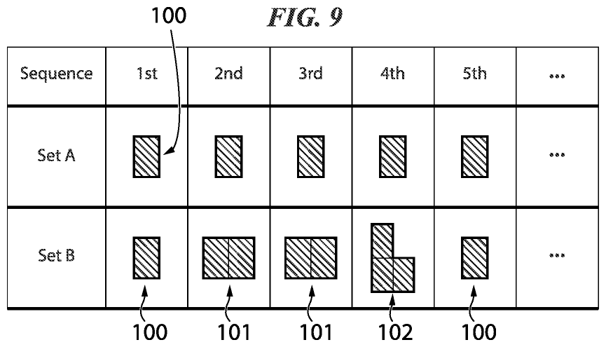

FIG. 9 shows example controllable objects that a user can control to manipulate mechanic objects, according to some embodiments of the present disclosure. When a user begins a test or game, he/she attempts to achieve a pre-specified goal or mission; this mission must be achieved with some constraints put into place to provide a challenge. In the context of the present disclosure, the constraints can be defined by the set of controllable objects that is provided to a user for a particular session. For example, “Set A” of FIG. 9 is a possible set; a user would be provided with five controllable objects 100 all of the same shape: the same shape as a field object. In another example, a user could be provided with “Set B” of FIG. 9, which includes various configurations of controllable objects 100-102, two of which are controllable objects 100.

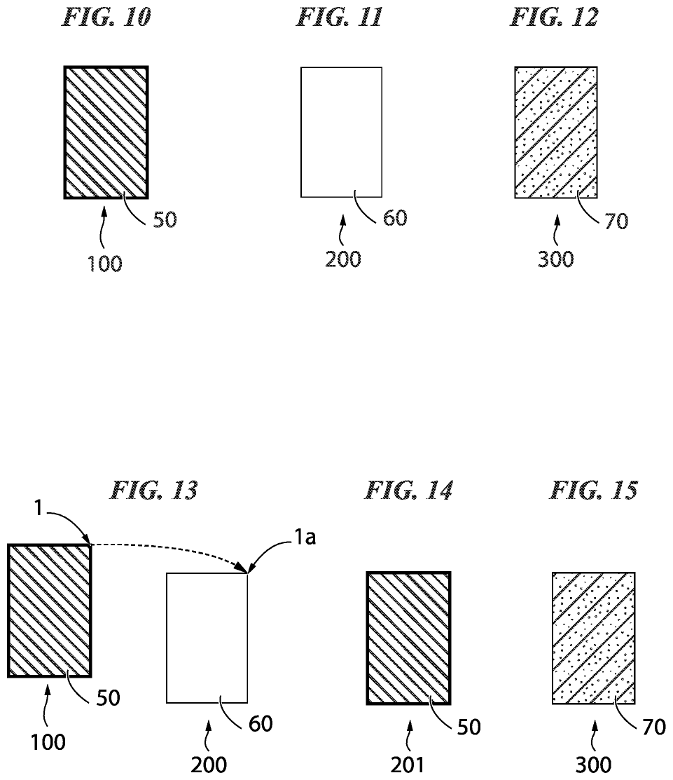

FIG. 10 is an example controllable object 100, according to some embodiments of the present disclosure. The controllable object 100 can include, for the sake of visual differentiation within the present disclosure, a pattern 50. However, in actual applications of the disclosed principles, a controllable object may have any visual appearance when displayed. FIG. 11 is an example field object 200, according to some embodiments of the present disclosure. The field object 200 can include, also for the sake of visual differentiation within the present disclosure, a pattern 60, although it is not required to have such a blank pattern and may have any visual appearance when displayed. FIG. 12 is an example active field object 300, according to some embodiments of the present disclosure. The active field object 300 can include, again for the sake of visual differentiation within the present disclosure, a pattern 70, although this is not required and any visual appearance during display is possible.

FIG. 13 shows an example of a controllable object 100 being manipulated by a user, according to some embodiments of the present disclosure. For example, a user can manipulate (e.g., click and drag) the controllable object 100 until a corner 1 aligns with a corner 1a of the field object 200. FIG. 14 shows the result of controllable object 100 overlaying a field object 200, according to some embodiments of the present disclosure. This can be referred to herein as an overlaid field object 201 that also has a pattern 50. In response to a user confirming a change to an active field object, the overlaid field object 201 can be converted to an active field object. FIG. 15 shows an example active field object 300 resulting from the manipulation of FIG. 13, according to some embodiments of the present disclosure. Active field object 300 now has pattern 70.

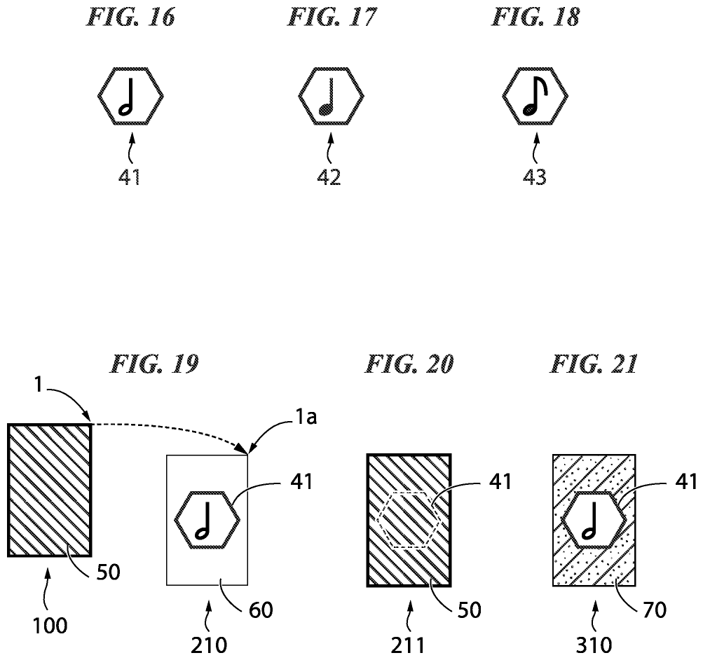

FIGS. 16-18 show example types of mechanic objects, according to some embodiments of the present disclosure. Within the context of the present disclosure, the visual appearances of the mechanic objects in FIGS. 16-18 is used to visually differentiate mechanic objects from other objects; however, this appearance of mechanic objects is not required nor is it limiting. Rather, the appearance using different musical notes is merely exemplary in nature and many possible icons or images could be used in their place. FIG. 16 shows an immobile mechanic object 41 (class CLR); FIG. 17 shows a horizontal mechanic object 42 (class CLD); FIG. 18 shows a vertical mechanic object 43 (class CLC).

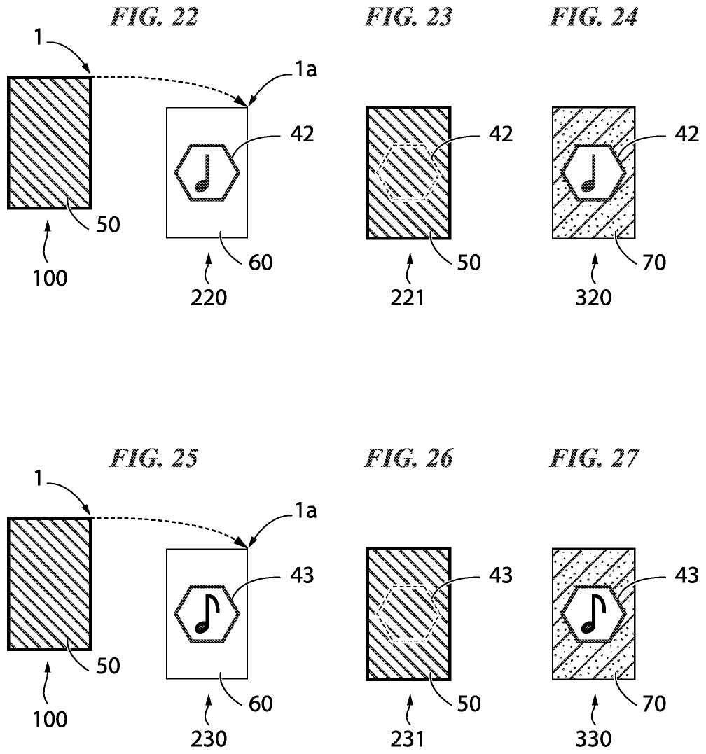

FIGS. 19-27 show examples of controllable objects being manipulated by a user, according to some embodiments of the present disclosure. FIG. 19 shows a controllable object 100 with pattern 50 being dragged to overlay a full field object 210 (e.g., a field object that contains a mechanic object, such as immobile mechanic object 41) with pattern 60 such that corner 1 aligns with corner 1a. FIG. 20 shows the overlaid full field object 211, which can be converted to an active field object in response to a confirmation by a user. In some embodiments, conversion to an active field object can also happen automatically. FIG. 21 shows a full active field object 310, which contains the immobile mechanic object 41 and now has a pattern 70. FIGS. 22-24 illustrate the same process as described in FIGS. 19-21 but with a horizontal mechanic object 42 within a full field object 220. The full field object 220 changes to an overlaid full field object 221 and then, once activated by a user, to a full active field object 320, which contains the horizontal mechanic object 42 and now has a pattern 70. FIGS. 25-27 also illustrate the same process as described in FIGS. 19-21 an 22-24 but with a vertical mechanic object 43 within a full field object 230. The full field object 230 changes to an overlaid full field object 231 and then, once activated, to a full active field object 330, which contains the vertical mechanic object 43 and now has a pattern 70.

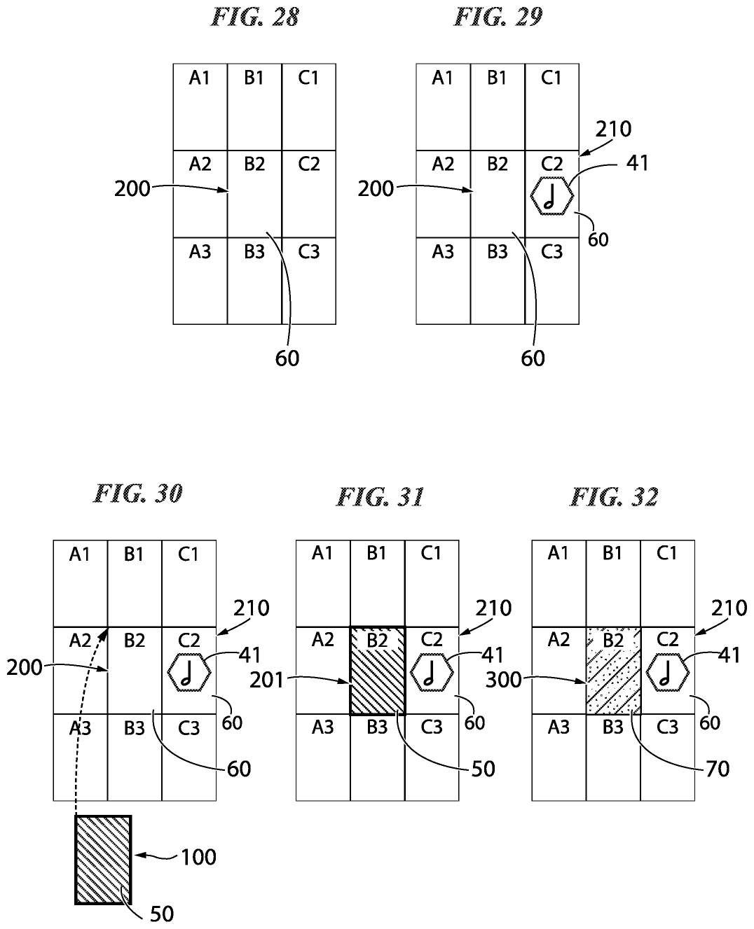

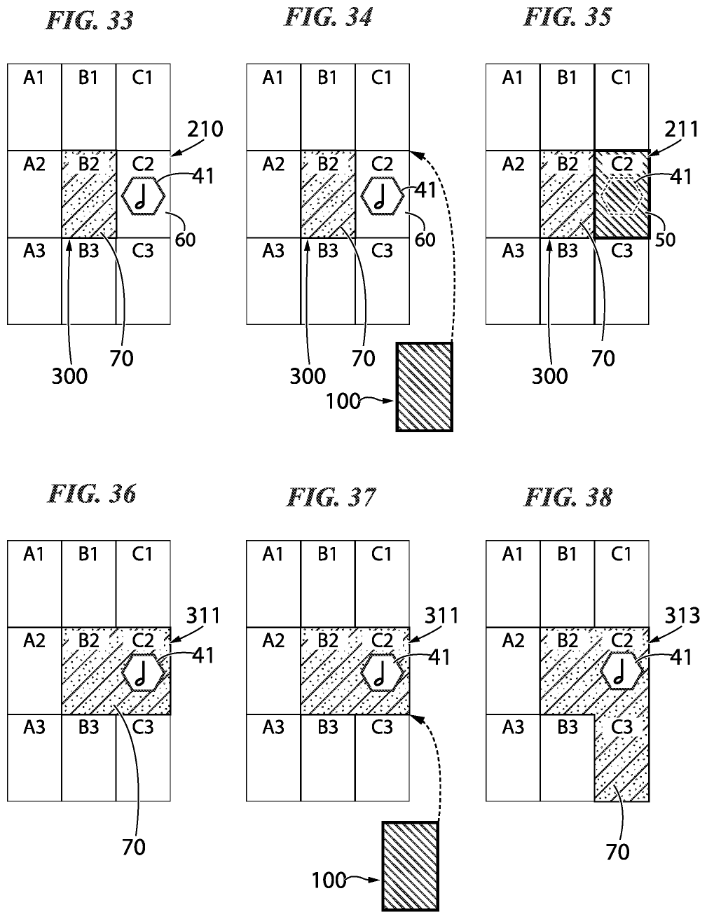

FIGS. 28-38 show example behavior of a mechanic object, according to some embodiments of the present disclosure. For example, FIG. 28 shows a field object grid with a plurality of field objects, such as field object 200 with pattern 60. FIG. 29 shows another field object grid with a plurality of field objects, such as field object 200 with pattern 60 and a full field object 210 containing an immobile mechanic object 41. FIG. 30 shows the field object grid of FIG. 29 and the process of a user manipulating a controllable object 100 with pattern 50 such that it overlays field object 200. FIG. 31 shows an overlaid field object 201. FIGS. 32 and 33 show an active field object 300 with pattern 70.

FIG. 34 shows the process of a user manipulating a second controllable object 100 onto the workplace of FIG. 33 such that it aligns with the C2 full field object that contains the immobile mechanic object 41. FIG. 35 shows an overlaid full field object 211 adjacent to active field object 300. Once activated, the full field object 211 becomes an active field object, shown in FIG. 36, which shows adjacent active field blocks that form an active field region 311 that contains the immobile mechanic object 41.

FIG. 37 shows the process of a user manipulating a third controllable object 100 onto the workplace of FIG. 36 such that it aligns with the C3 field object. FIG. 38 shows a new active field region 313, where field objects B2, C2, and C3 have all been converted to active field objects with pattern 70. Additionally, because the only mechanic object contained within the active field region 313 is an immobile mechanic object, the immobile mechanic object 41 does not move (see FIG. 5).

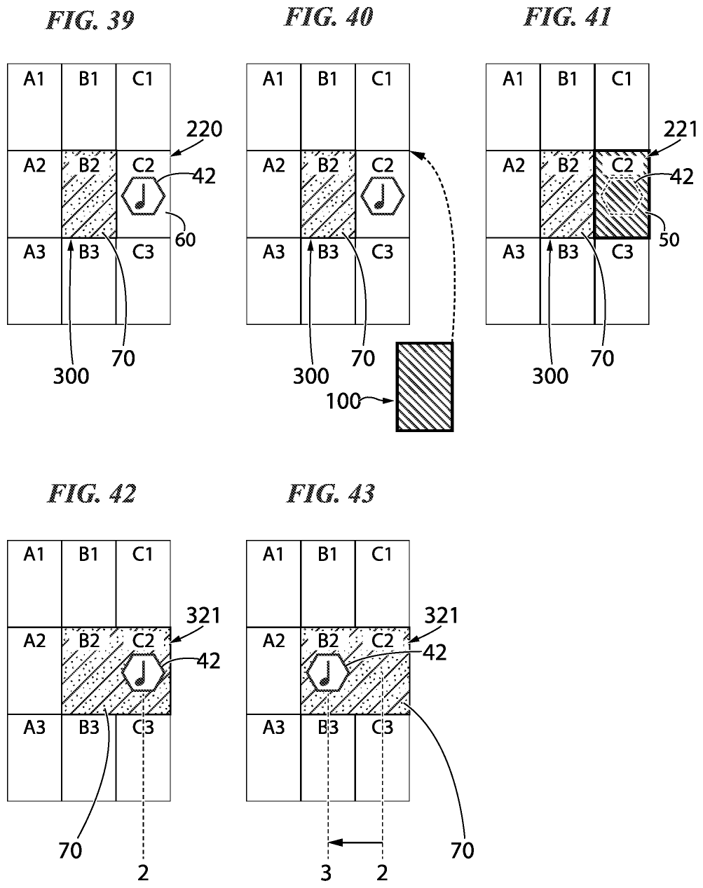

FIGS. 39-43 show additional example behavior of a mechanic object, according to some embodiments of the present disclosure. For example, FIG. 39 shows a field object grid with a plurality of field objects, such as an active field object 300 with pattern 70 and a full field object 220 with pattern 60 that contains a horizontal mechanic object 42. FIG. 40 shows the process of a user manipulating a controllable object 100 onto the field object grid of FIG. 39 such that it overlays full field object 220 and is adjacent to active field object 300. FIG. 41 shows an overlaid field object 221 with pattern 50 that contains horizontal mechanic object 42. FIG. 42 shows the field object grid once overlaid full field object 221 is activated (e.g., by the user or automatically by the server) and becomes an active field object 321 with pattern 70 that contains horizontal mechanic object 42 at position 2.

As described in FIG. 6A at block S305, when a horizontal mechanic object 42 is within an active field region, it will move horizontally across the various active field objects within the region. FIG. 43 shows the process of horizontal mechanic object 42 moving horizontally from position 2 in active field object 321 (C2) to position 3 (B2).

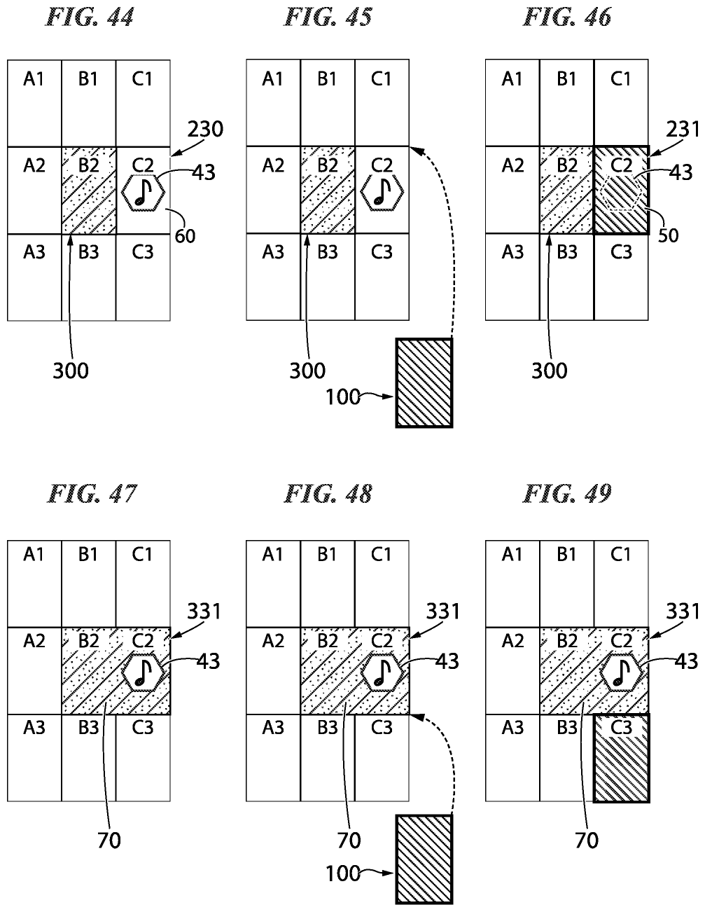

FIGS. 44-51 show additional example behavior of a mechanic object, according to some embodiments of the present disclosure. For example, FIG. 44 shows a field object grid with a plurality of field objects, such as an active field object 300 and a full field object 230 with pattern 60 that contains a vertical mechanic object 43. FIG. 45 shows the process of a user manipulating a controllable object 100 onto the field object grid of FIG. 44 such that it overlays full field object 230 and is adjacent to active field object 300. FIG. 46 shows an overlaid field object 231 with pattern 50 that contains vertical mechanic object 43. FIG. 47 shows the field object grid once overlaid full field object 231 is activated (e.g., by a user or automatically by the server) and becomes an active field object 331 with pattern 70 that contains vertical mechanic object 43.

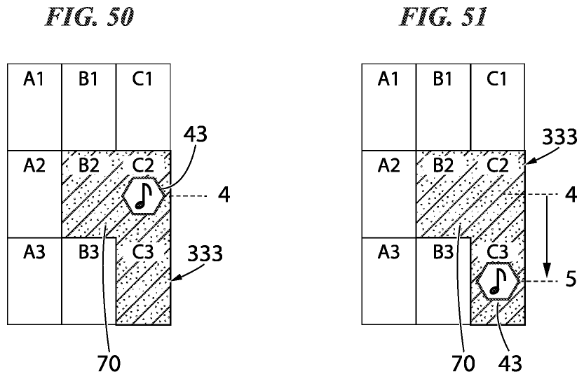

FIG. 48 shows the process of a user manipulating an additional controllable object 100 onto the field object grid of FIG. 47 such that it overlays the field object at C3 and is underneath the active field object 331. FIG. 49 shows an overlaid field object at C3. FIG. 50 shows the field object grid once the overlaid field object at C3 is activated and becomes an active field region 333 with pattern 70. The vertical mechanic object 43 is at position 4 (C2). As described in FIG. 7A at S405, when a vertical mechanic object 43 is within an active field region, it will move vertically across the various active field objects within the region. FIG. 51 shows the process of vertical mechanic object 43 moving vertically from position 4 (C2) within active field region 333 to position 5 (C3).

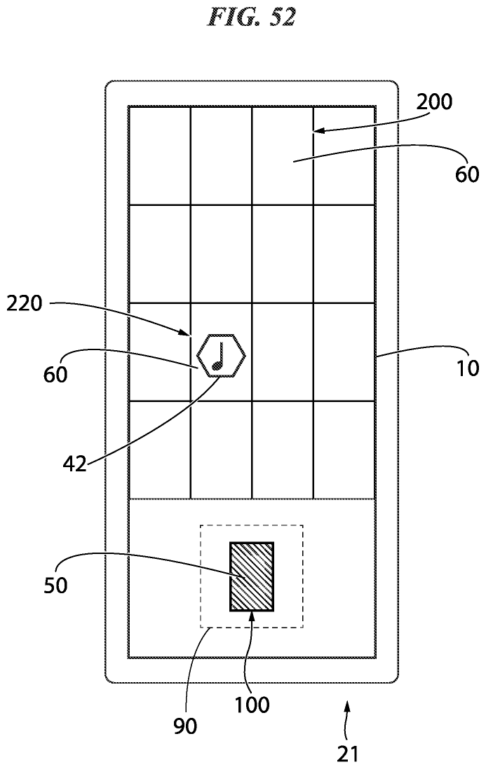

FIG. 52 shows an example interface 10 displayed to a user, according to some embodiments of the present disclosure. The interface 10, which can be displayed on a mobile device 21, includes a controllable object 100 with pattern 50 that is available for a user to move via a selectable region 90. In addition, the interface 10 can include a field object 200 with pattern 60 and a full field object 220 with pattern 60 that contains a horizontal mechanic object 42.

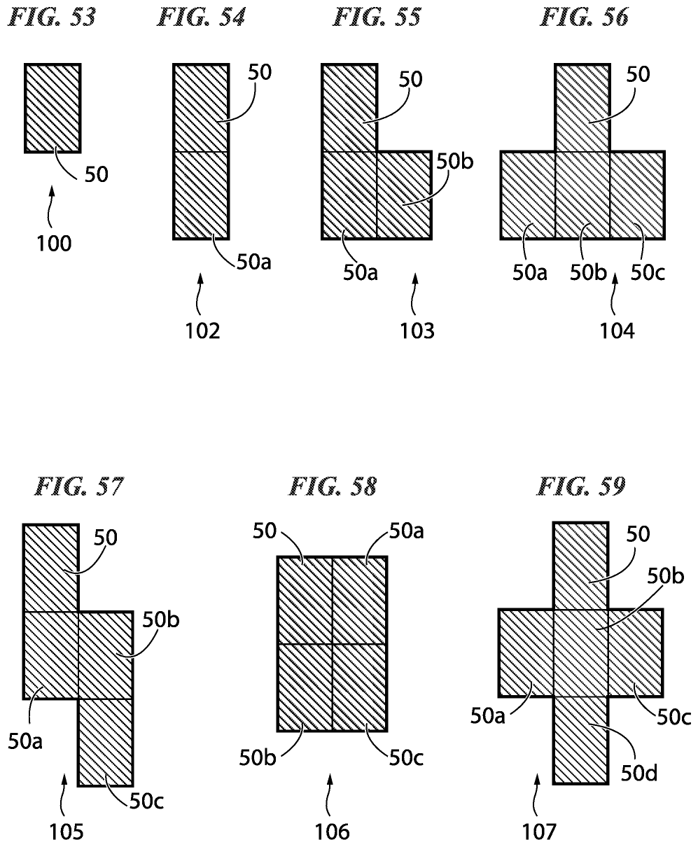

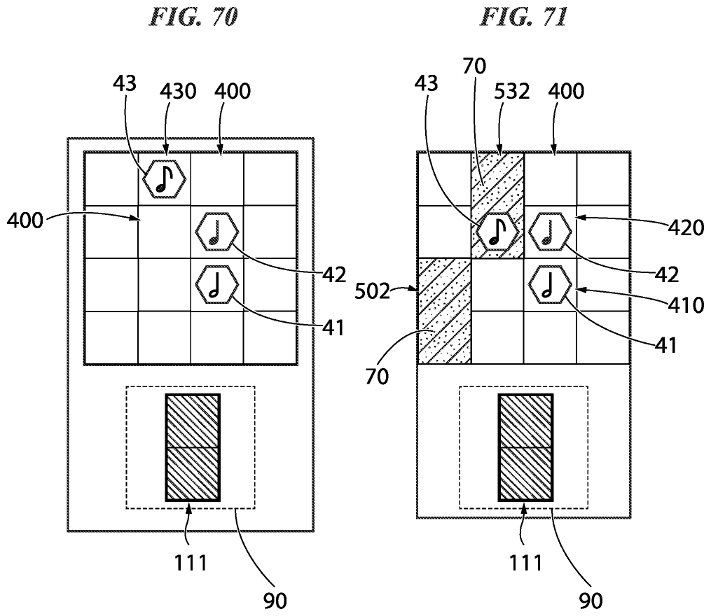

FIGS. 53-69 show example controllable objects, according to some embodiments of the present disclosure, each of which with a pattern 50 or pattern 50a-g. Within the context of the present disclosure, the controllable objects provided to a user to complete a game or test can be in a variety of shapes. This allows the difficulty of levels to be controlled and a greater flexibility in game design. While non-exhaustive, potential controllable objects for a system that utilizes rectangular field objects can include a controllable object 100 that aligns with one field object (FIG. 53), a controllable object 102 that aligns with two field objects (FIG. 54), a controllable object 103 that aligns with three field objects (FIG. 55), various controllable objects 104-106 that align with four field objects (FIGS. 56-58), and a controllable object 107 that aligns with five field objects (FIG. 59).

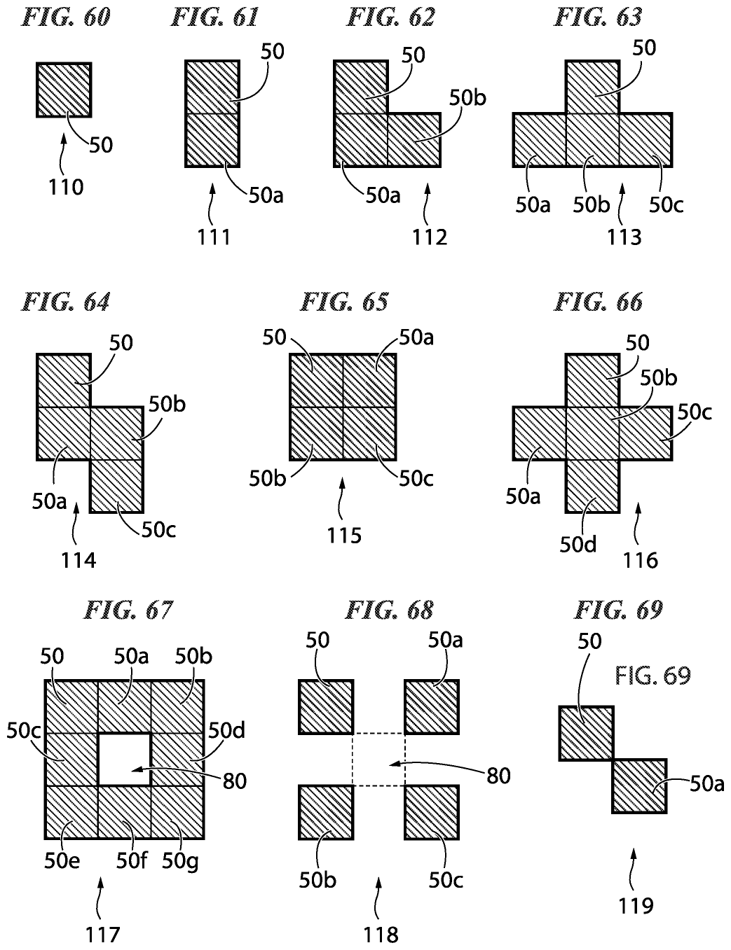

In other embodiments, the disclosed principles may utilize field objects in the field object grid that are less elongated and more square-like. For example, see controllable objects 110-119 in FIGS. 60-69. Although different in shape and pattern, a user can control these controllable objects in the same way as previous types described herein.

FIGS. 70-71 show example interfaces displayed to a user, according to some embodiments of the present disclosure. For example, the interface of FIGS. 70-71 can include a field object grid with a plurality of square field objects 400, which can also herein be described singularly as a square field object 400. The interface also includes a full field object 430 that contains a vertical mechanic object 43, a full field object 420 that contains a horizontal mechanic object 42 and a full field object 410 that contains an immobile mechanic object 41, and a controllable object 111 with selectable region 90. FIG. 71 shows the interface of FIG. 70 after a user has placed two controllable objects 111 onto the field object grid, creating an active field object 502 and an active field object 532 that contains the vertical mechanic object 43, each of which with a pattern 70.

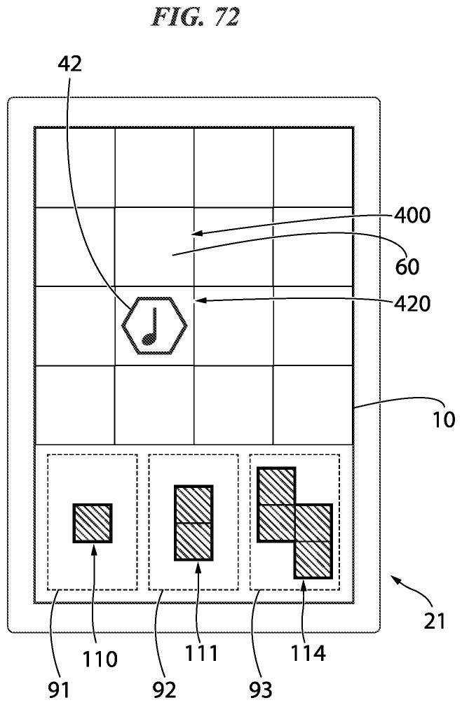

FIG. 72 shows another example interface 10 displayed to a user on a mobile device 21, according to some embodiments of the present disclosure. The interface 10 can include a plurality of controllable objects 110, 111, and 114 available for a user to place onto the plurality of field objects 400 with pattern 60 (including full field object 420 that contains a horizontal mechanic object 42).

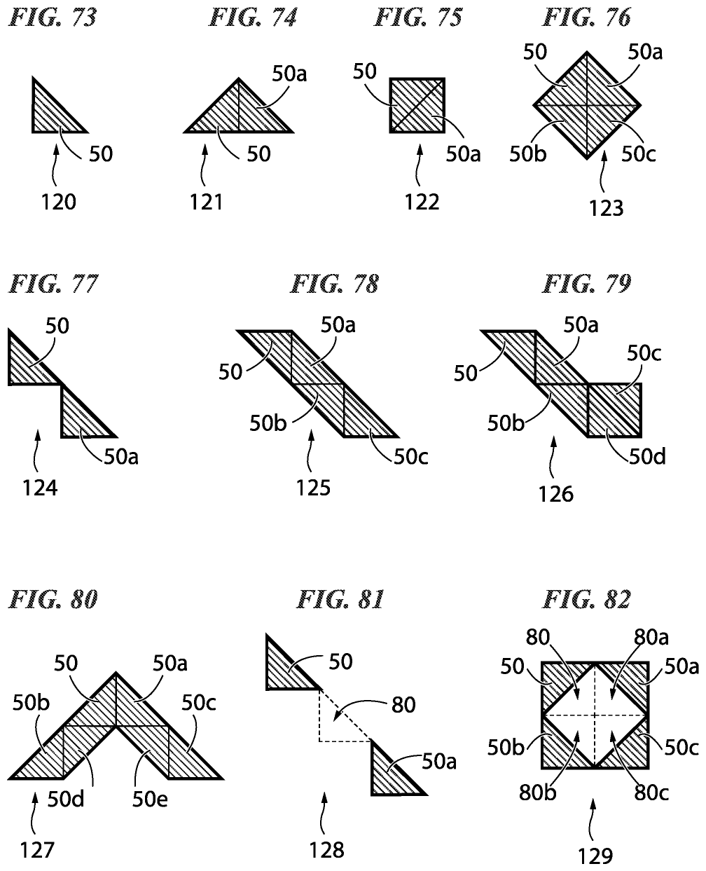

FIGS. 73-82 show additional example controllable objects, according to some embodiments of the present disclosure. As discussed above, the shape and/or pattern of controllable objects within the context of the present disclosure is not limited to any particular shape (e.g., rectangles, square, or other quadrilaterals). For example, in some embodiments, the controllable objects and associated field objects can be triangular. Controllable objects 120-129 with patterns 50a-e of FIGS. 73-82 can be provided to a user and utilized in the disclosed game or test applications. In some embodiments, such as in FIGS. 81 and 82, the controllable object 128 or 129 can also include an invisible controllable object 80 that render on the user's display but disable behavior of mechanic objects.

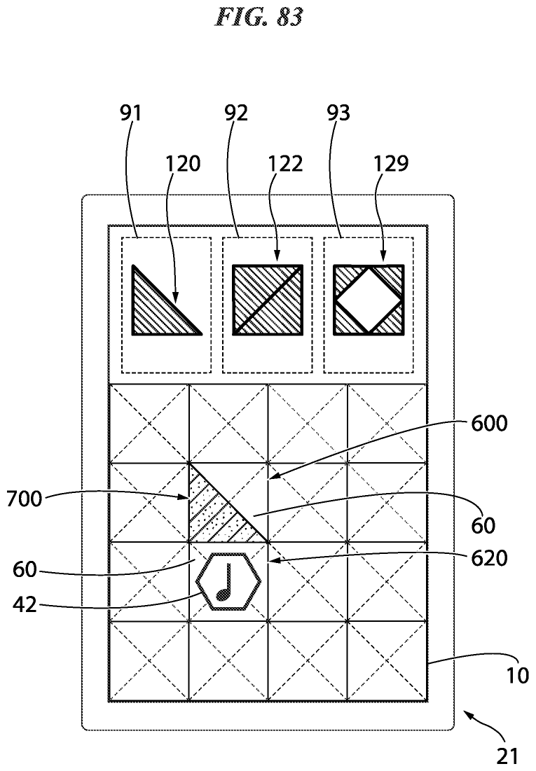

FIGS. 83-88 show additional example interfaces 10 displayed to a user on a mobile device 21, according to some embodiments of the present disclosure. The display of FIG. 83 involves a triangular theme and includes triangular pattern-based controllable objects 120, 122, and 129 and selectable regions 91-93, respectively. The display also includes a plurality of field objects 600, a full field object 620 with horizontal mechanic object 42 and pattern 60, and an active field region 700.

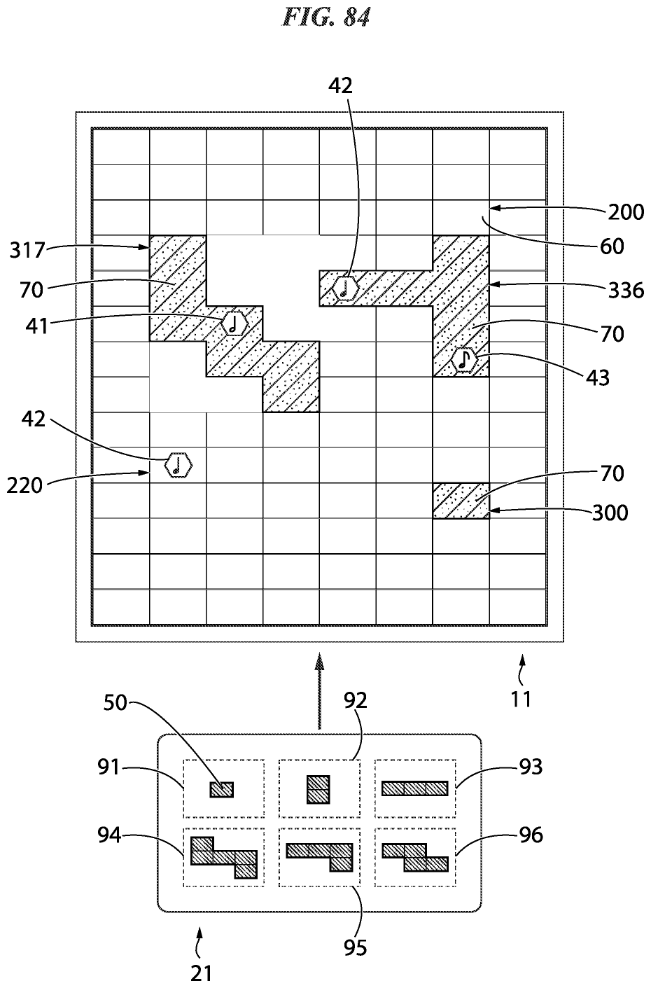

FIG. 84 shows a display 11 that includes rectangular controllable objects that can be manipulated by a user via selectable regions 91-96. The field object grid includes a plurality of field objects 200 with pattern 60, a full field object 220 with a first horizontal mechanic object 42, an active field object 300 with pattern 70, an active field region 317 that contains immobile mechanic object 41, and an active field region 336 that contains a second horizontal mechanic object 42 and a vertical mechanic object 43. Based on the behavior described in FIGS. 5-7, the second horizontal mechanic object 42 in the active field region can move horizontally and the vertical mechanic object 43 can move vertically.

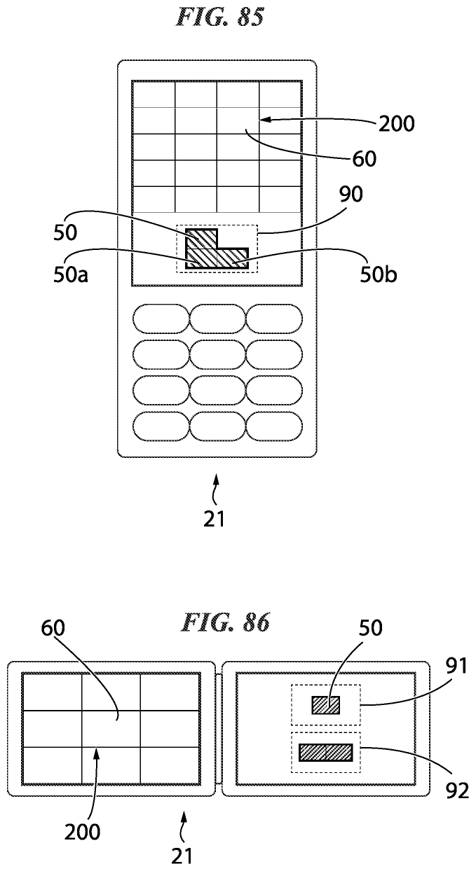

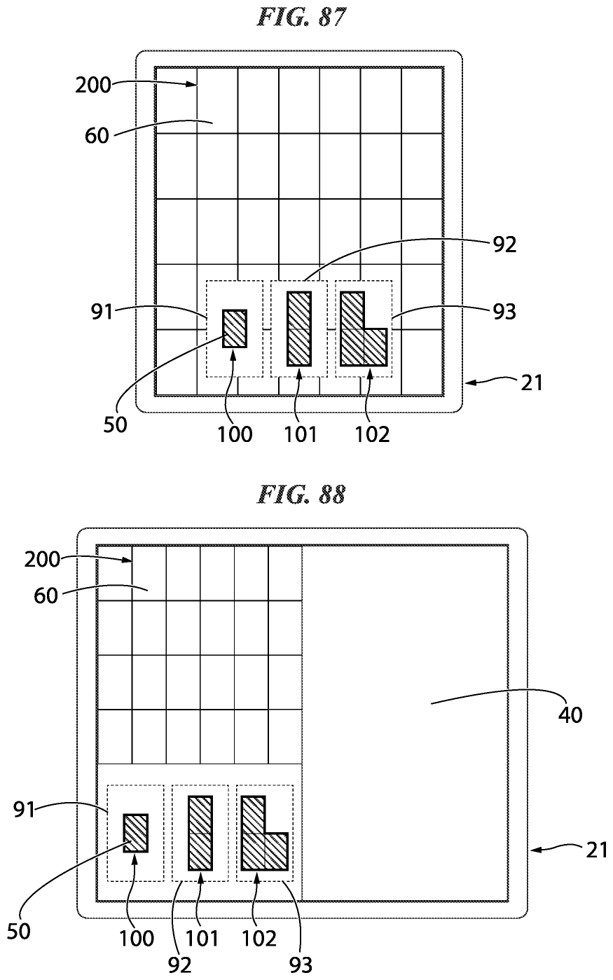

FIGS. 85 and 86 show additional examples of possible displays that utilize the disclosed principles. For example, FIG. 85 shows a mobile device 21 with a controllable object with patterns 50 and 50a-b and a selectable region 90 with which a user can use to manipulate the controllable object onto a plurality of field objects 200 with pattern 60. FIG. 86 shows an embodiment of the present disclosure where the available controllable objects and associated selectable regions 91 and 92 are displayed to the right of the plurality of field objects 200 rather than below. FIG. 87 shows another possible embodiment of displaying a field object grid and available controllable objects to a user on device 21; the controllable objects 100-102 and respective selectable regions 91-93 can be displayed on top of the plurality of field objects 200. FIG. 88 shows another possible embodiment of displaying controllable objects 100-102 and the plurality of field objects 200 that includes an information screen 40. In some embodiments, the information screen 40 can include a mission screen 801, fail screen 802, success screen 803, clues, test progress, a user score, answers, test results, real-time simulation results, etc.

FIG. 89 shows an example mission or goal that can be displayed to a user prior to beginning a session, according to some embodiments of the present disclosure. The interface 10 can include a mission screen 801 that provides specifics on what the user needs to achieve to successfully “win” a game or test. The mission screen 801 can include the mechanic objects that the user must attempt to achieve by manipulating various controllable objects and the required quantity of each. For example, a user must achieve a vertical mechanic object 812 with a level two status (quantity 811), a horizontal mechanic object 814 (quantity 813), and an immobile mechanic object 816 (quantity 815). In some embodiments, the number of eighth notes within the hexagonal icon can reflect the “level” status of a mechanic object.

FIGS. 90-91 show example interfaces that can be displayed to a user upon completion of a session, according to some embodiments of the present disclosure. If the user is participating in a game or test application as described herein and fails to achieve the pre-specified mission (e.g., uses up all originally allocated controllable objects before having reached the mission's requirements), a fail screen 802 may be displayed to the user (FIG. 90). Similarly, if the user does reach the mission's requirements before exhausting the allocated controllable objects, a success screen 803 may be displayed to the user (FIG. 91).

FIGS. 92-107 show an example of a failed session of a user playing an object management game, according to some embodiments of the present disclosure. For exemplary purposes, and not as a limiting example, the user may be attempting to achieve the mission displayed in mission screen 801 of FIG. 89. FIG. 92 shows an interface 10 that is displayed to a user at the beginning of a session, after the user has been shown the mission screen 801. Interface 10 includes a field object grid 17 and five mechanic objects: a first vertical mechanic object 43 (D1), a second vertical mechanic object 43 (B2), a horizontal mechanic object 42 (A3), a third vertical mechanic object 43 (B4), and an immobile mechanic object 41 (D4). The interface 10 also specifies to the user that controllable objects 100-102 are available for manipulation via selectable regions 91-93, respectively. In addition, the interface 10 specifies the available quantity of each respective controllable object via numerical displays 821-823.

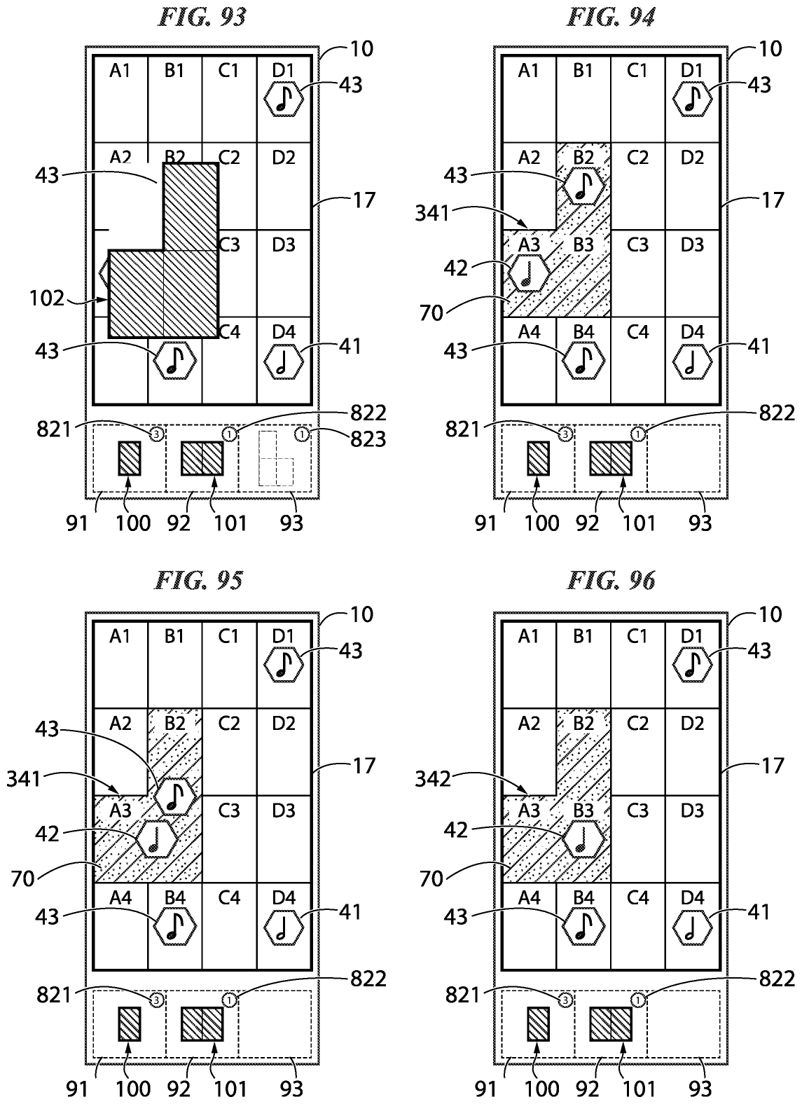

FIG. 93 shows the process of a user moving the controllable object 102 (e.g., via a click and drag process) onto the field object grid 17 such that it overlays the field objects at B2, A3, and B3. FIG. 94 shows the result of placing the controllable object 102, which converts the field objects at B2, A3, and B3, which contain the second vertical mechanic object 43 and the horizontal mechanic object 42, to active field objects. As described in FIGS. 5-7, a server controlling behavior and operations of the game or test will cause the relevant mechanic objects within the active field region to move. As shown in FIG. 95, second vertical mechanic object 43 moves vertically between B2 and B3 (block S405), while the horizontal mechanic object 42 moves horizontally between A3 and B3 (block S305). FIG. 96 shows the result of a collision between the second vertical mechanic object 43 and the horizontal mechanic object 42 (blocks S306-S309). Because the horizontal mechanic object 42 (CLD) collided with a vertical mechanic object 43 (CLC), the horizontal mechanic object 42 obtains the corresponding value (1) from the vertical mechanic object 43 and the server changes the parameter of the vertical mechanic object 43 to “false”, which makes it disappear from the display. There is no effect on the first vertical mechanic object 43, the third vertical mechanic object 43, or the immobile mechanic object 41 because none of these are within an active field. Additionally, FIGS. 94-96 no longer display the controllable object 102 as being available for manipulation.

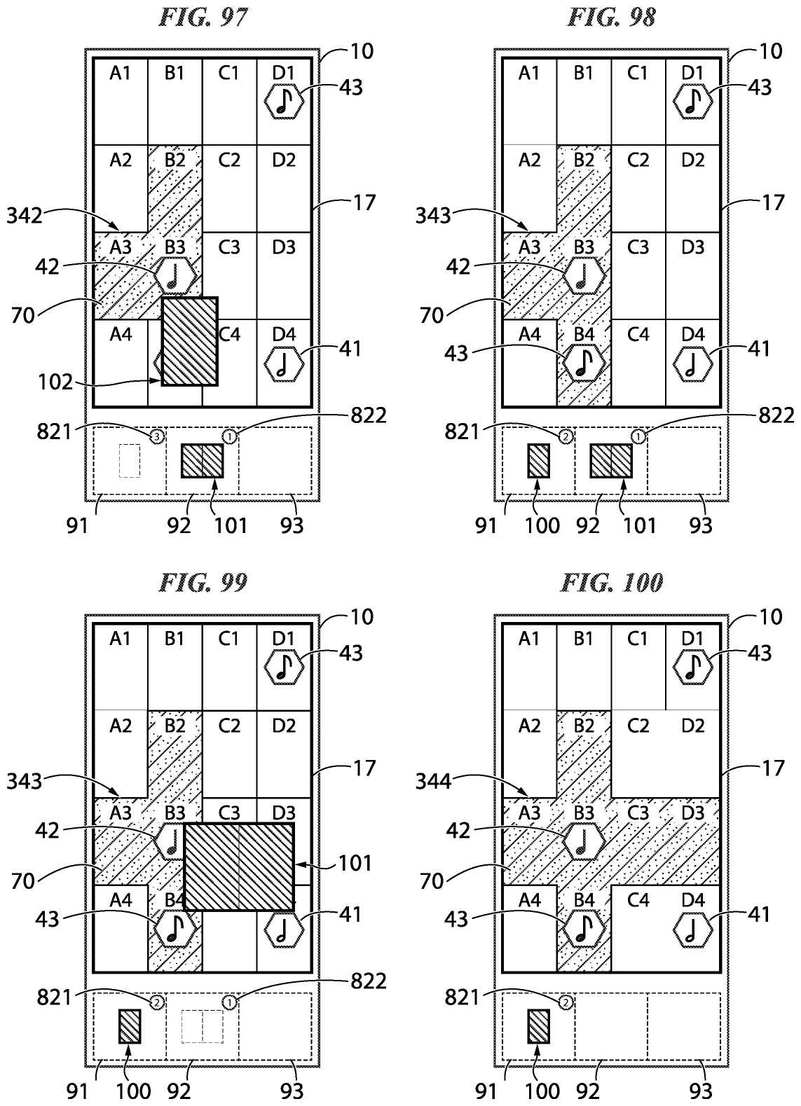

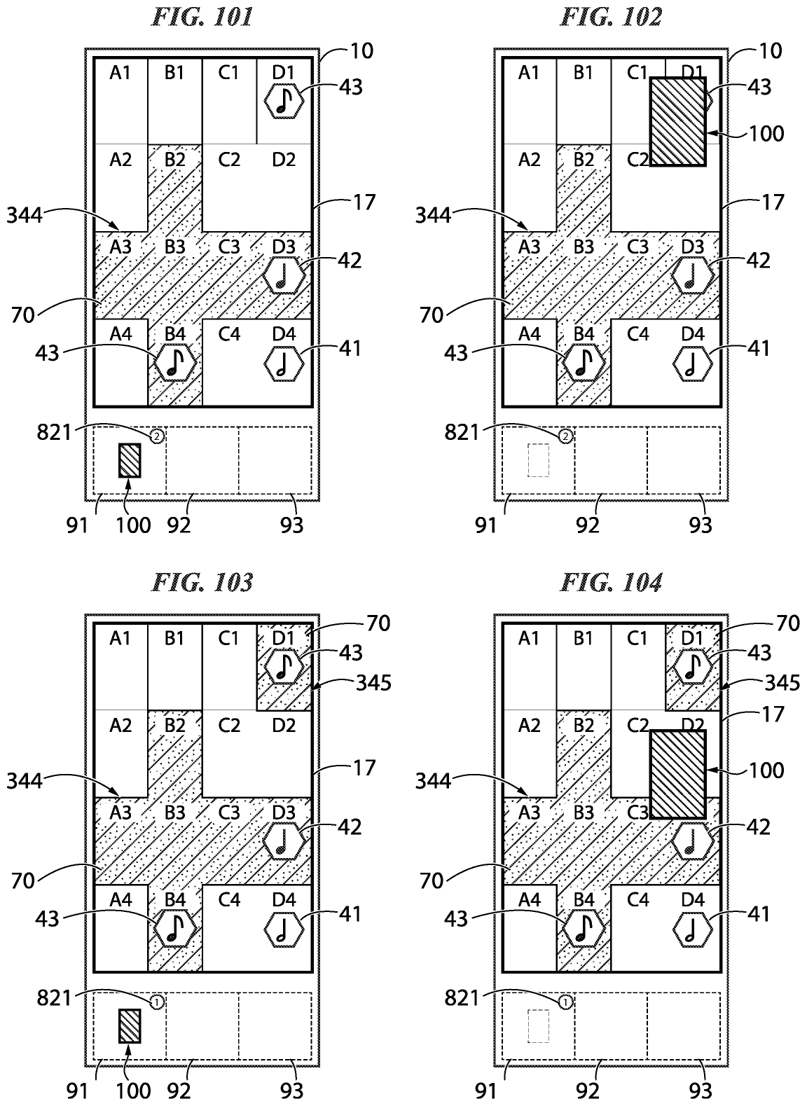

FIG. 97 shows the process of the user moving the controllable object 100 onto the field object grid 17 such that it overlays the field object at B4. FIG. 98 shows the result of placing the controllable object 100, which converts the field object at B4 to an active field object and extends the active field region. FIG. 99 shows the process of the user moving a controllable object 101 onto the field object grid 17 such that it overlays the field objects at C3 and D3. FIG. 100 shows the result of placing the controllable object 101, which converts the field objects at C3 and D3 to active field objects. Again, the server controlling behavior and operations of the game or test will cause the relevant mechanic objects within the active field region to move. As shown in FIG. 101, the horizontal mechanic object 42 moves horizontally along the third row (A3-D3). Additionally, the interface 10 of FIGS. 100 and 101 no longer display the controllable object 101 as being available for manipulation.

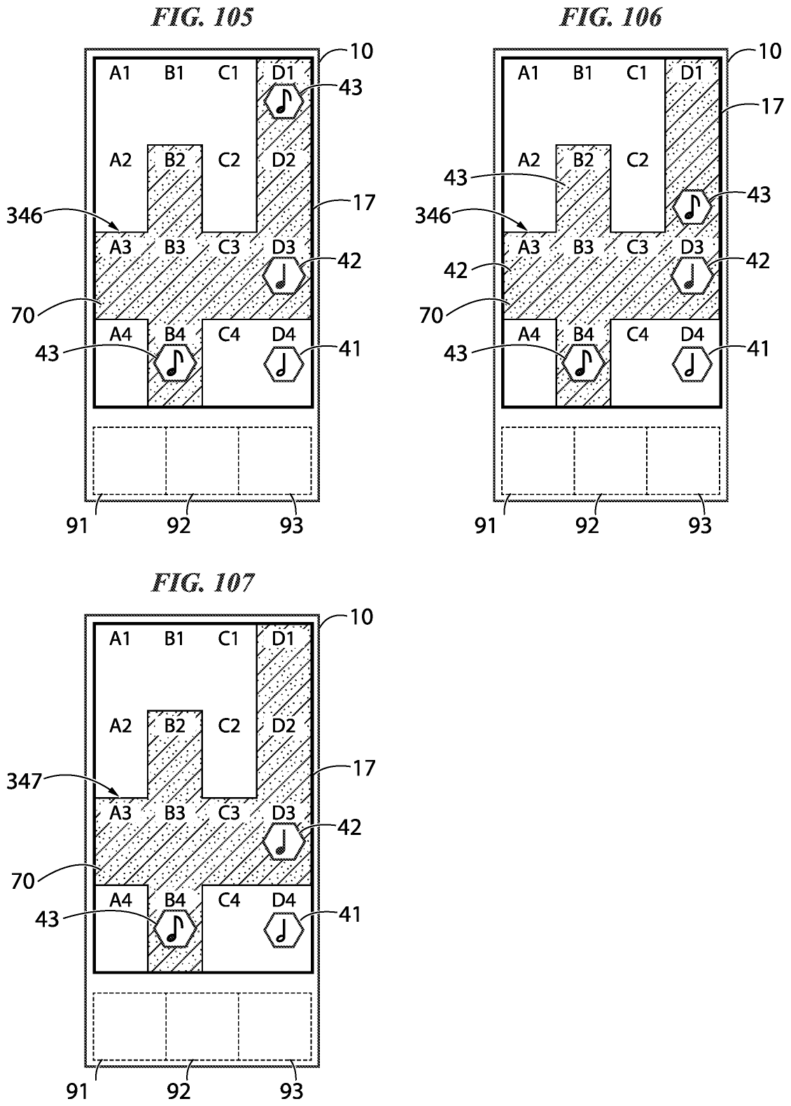

FIG. 102 shows the process of the user moving another controllable object 100 onto the field object grid 17 such that it overlays with the field object at D1. FIG. 103 shows the result of placing the controllable object 100, which converts the field object at D1 to an active field object. Additionally, the count of the available controllable objects 100 is reduced by one. FIG. 104 shows the process of the user moving the third and final controllable object 100 onto the field object grid 17 such that it overlays the field object at D2. FIG. 105 shows the result of placing the controllable object 100, which converts the field object at D2 to an active field object. As a result, the server controlling behavior and operations of the game or test will cause the relevant mechanic object within the active field region to move. As shown in FIG. 106, the first vertical mechanic object 43 moves vertically along the fourth column (D1-D3). FIG. 107 shows the result of the collision between the first vertical mechanic object 43 and the horizontal mechanic object 42 (blocks S306-S309). Again, because the horizontal mechanic object 42 (CLD) collided with a vertical mechanic object 43 (CLC), the horizontal mechanic object 42 obtains the corresponding value (1) from the vertical mechanic object 43 and the server changes the parameter of the vertical mechanic object 43 to “false”, which makes it disappear from the display. Additionally, because the user has no remaining controllable objects to manipulate (e.g., selectable regions 91-93 are blank) and has one immobile mechanic object, one horizontal mechanic object, and one vertical mechanic object at level one (as opposed to one immobile mechanic object, one horizontal mechanic object, and one vertical mechanic object at level two, as specific by the mission screen 801), the user has failed the mission and a fail screen could be displayed to the user.

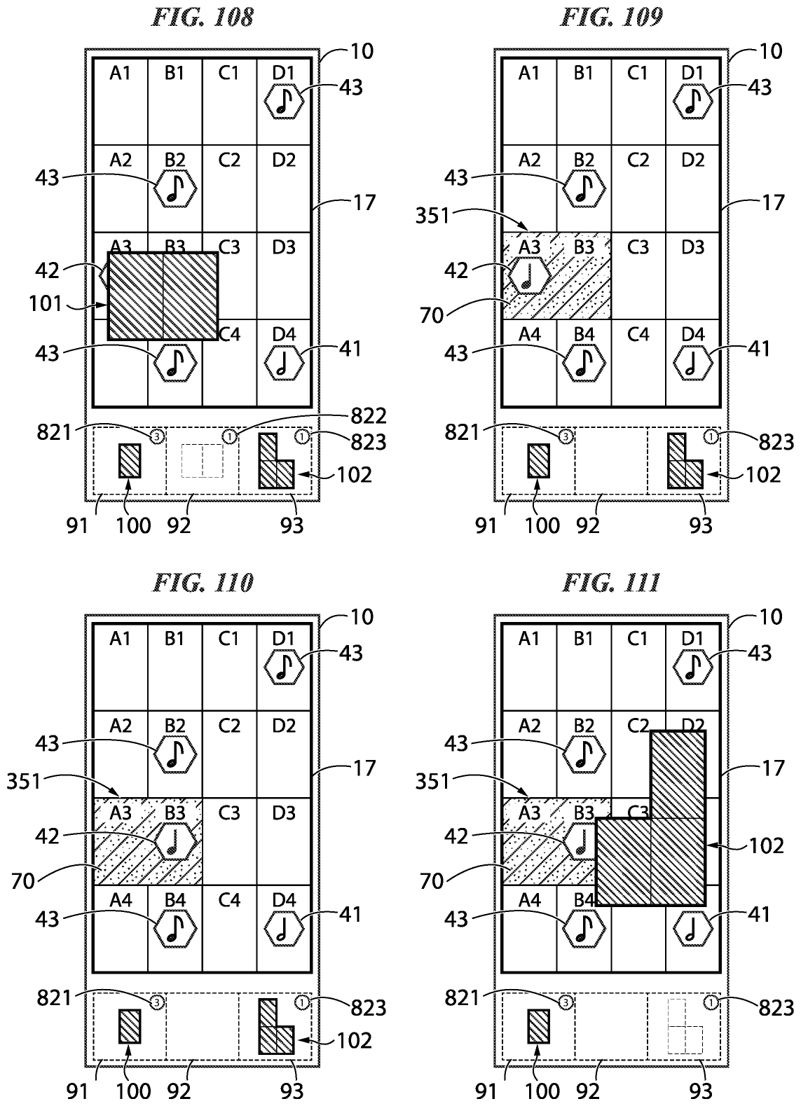

FIGS. 108-124 show an example of a successful session of a user playing an object management game, according to some embodiments of the present disclosure. Again, for exemplary purposes, and not as a limiting example, the user may be attempting to achieve the mission displayed in mission screen 801 of FIG. 89. FIG. 108 shows the process of a user moving a controllable object 101 (e.g., via a click and drag process) onto the field object grid 17 (e.g., the same field object grid 17 as displayed in FIG. 92) such that it overlays the field objects at A3 and B3. FIG. 109 shows the result of placing the controllable object 101, which converts the field object at A3 and B3 containing the horizontal mechanic object 42 to active field objects. As described in FIGS. 5-7, a server controlling behavior and operations of the game or test will cause the relevant mechanic objects within an active field region to move. As shown in FIG. 110, the horizontal mechanic object 42 moves within the active field region 351.

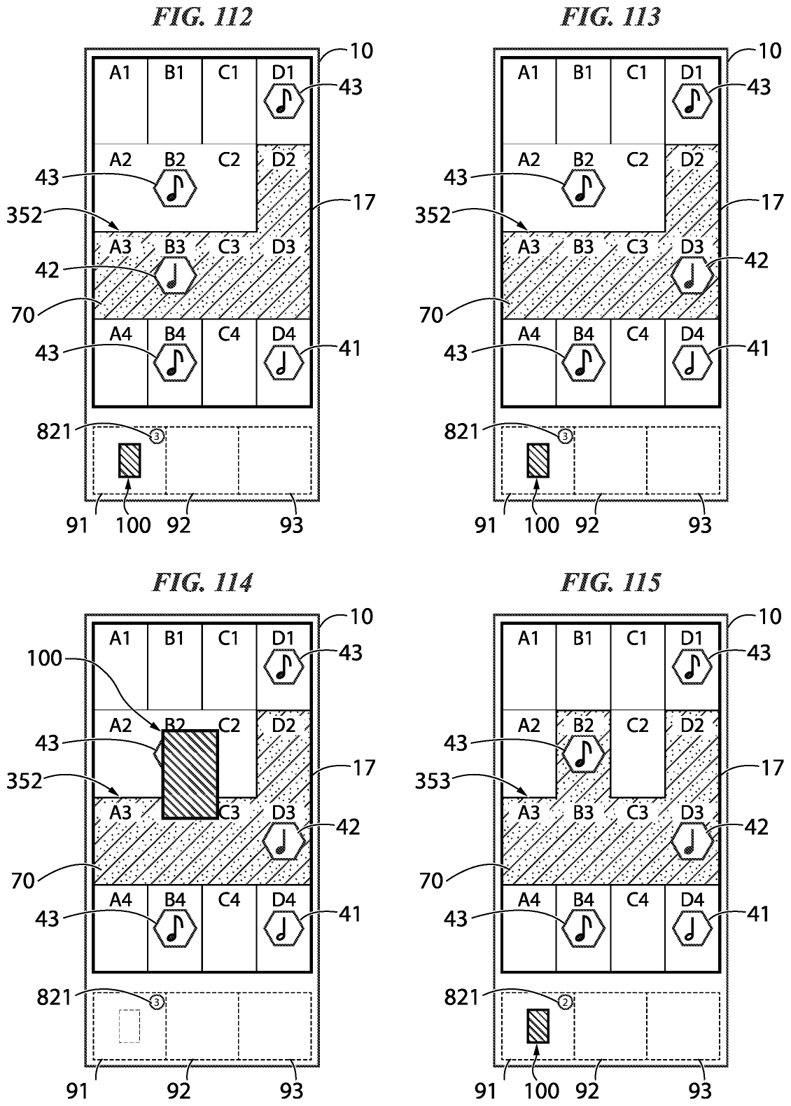

FIG. 111 shows the process of the user moving a controllable object 102 onto the field object grid 17 such that it overlays the field objects at D2, C3, and D3. FIG. 112 shows the result of placing the controllable object 102, which converts the field objects at D2, C3, and D3 to active field objects and forms a larger active field region 352. FIG. 113 shows that the horizontal mechanic object 42 continues to move horizontally to D3 after the active field region is extended in a horizontal direction.

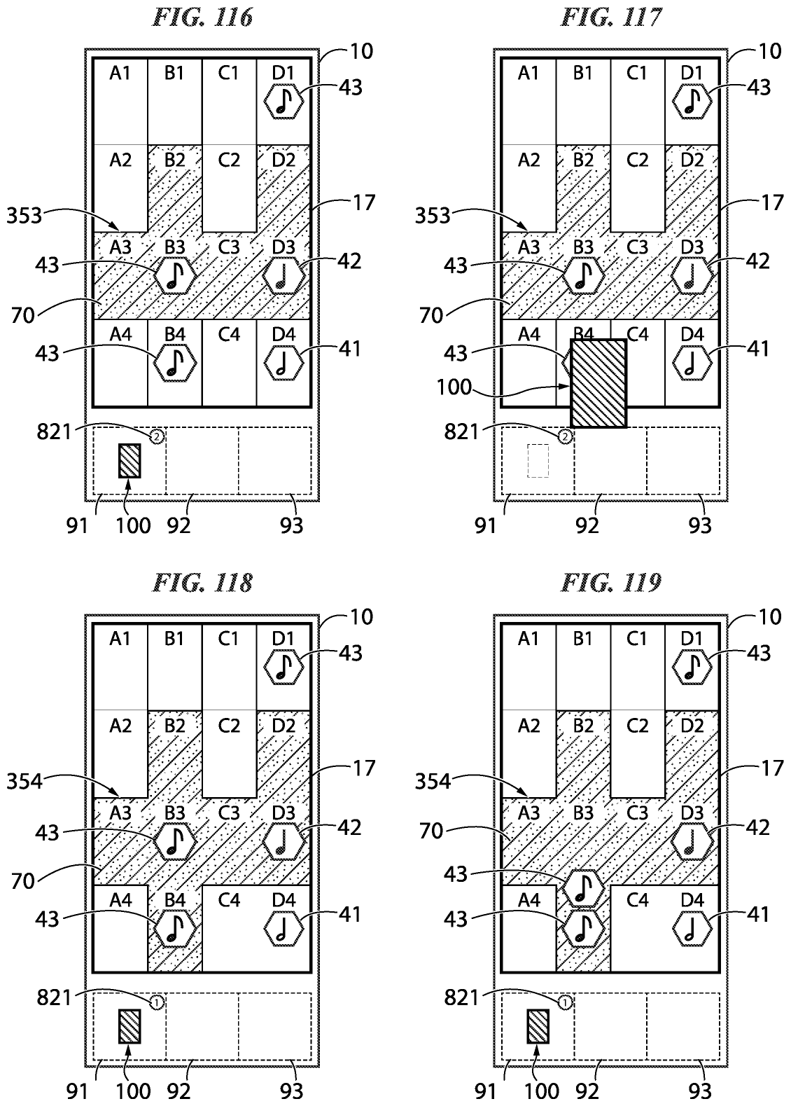

FIG. 114 shows the process of the user moving a controllable object 100 onto the field object grid 17 such that it overlays with the field object at B2, which contains the second vertical mechanic object 43. FIG. 115 shows the result of the user placing the controllable object 100, which converts the field object at B2 to an active field object and forms a larger active field region 353. Because the second vertical mechanic object 43 is now within an active field object region 353, the server controlling behavior and operations of the game or test will cause it to move vertically downward to B3, as shown in FIG. 116.

FIG. 117 shows the process of the user moving another controllable object 100 onto the field object grid 17 such that it overlays the field object at B4 containing the third vertical mechanic object 43. FIG. 118 shows the result of the user placing the controllable object 100, which converts the field object at B4 to an active field object and forms a larger active field region 354. Because the active field region 354 now extends the vertical path downward for the second vertical mechanic object 43, it continues to move downward as a result of instructions from the server, as shown in FIG. 119.

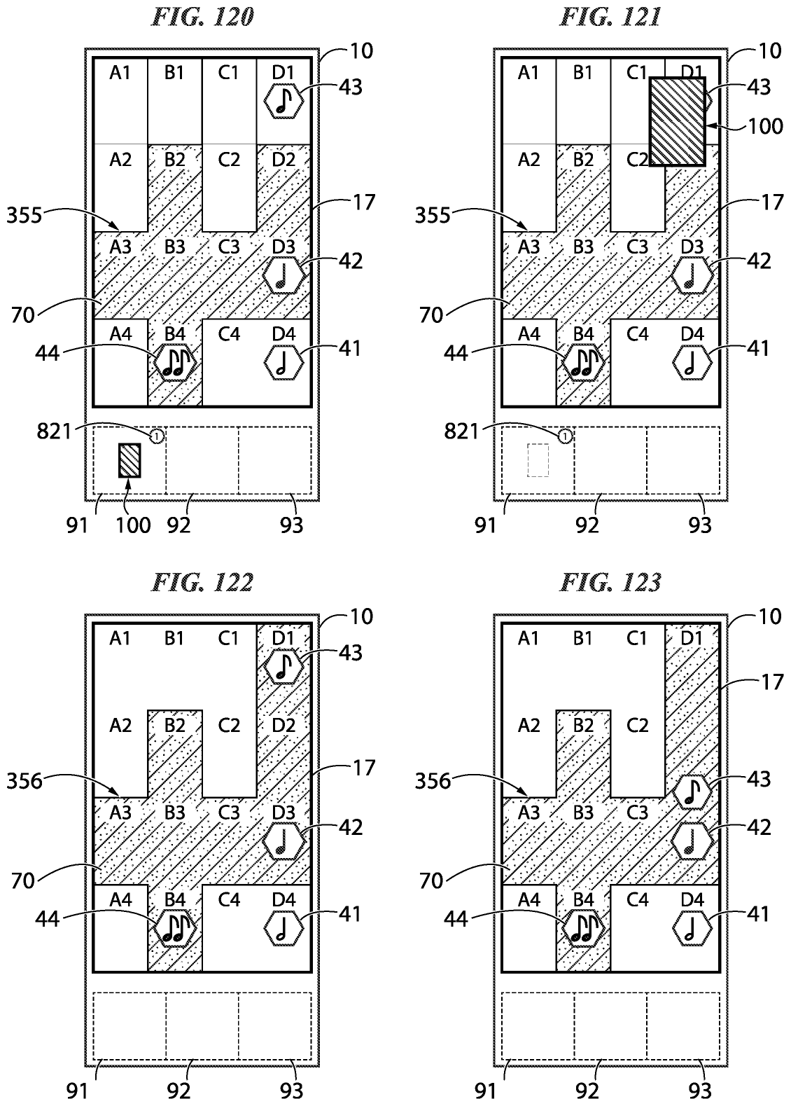

FIG. 120 shows the result of the collision between the second and third vertical mechanic objects as a result of the downward movement of the second vertical mechanic object 43 in FIG. 119. As described in blocks S406-S409 of FIG. 7, if two vertical mechanic objects collide, the server changes the parameter of the vertical mechanic object that collided from above to “false”, which makes it disappear from the user's display. The server also changes the parameter value of the vertical mechanic object that collided from below to the sum of the two mechanic objects, which in this case is two. Because the vertical mechanic object 43's value is now two, the server changes the display to include two eighth notes in the hexagonal icon.

FIG. 121 shows the process of a user moving the final controllable object 100 onto the field object grid 17 such that it overlays the field object at D1 containing the first vertical mechanic object 43. FIG. 122 shows the result of the user placing the controllable object 100, which converts the field object at D1 to an active field object and forms a larger active field region 355. Because the active field region 354 now offers a vertical path downward for the first vertical mechanic object 43, it continues to move downward as a result of instructions from the server, as shown in FIG. 123.

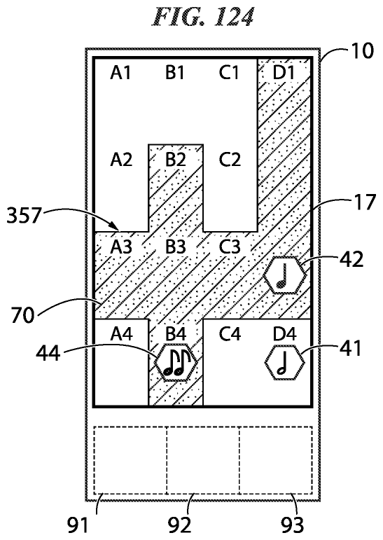

FIG. 124 shows the result of the collision between the first vertical mechanic object 43 and the horizontal mechanic object 43 at D3. As described in blocks S306-S309 of FIG. 6, because the horizontal mechanic object 42 (CLD) collided with a vertical mechanic object 43 (CLC), the horizontal mechanic object 42 obtains the corresponding value (1) from the vertical mechanic object 43 and the server changes the parameter of the vertical mechanic object 43 to “false”, which makes it disappear from the display. The interface 10 of FIG. 124 now displays an immobile mechanic object 41, a horizontal mechanic object 42, and a vertical mechanic object of level two status 44, which matches the originally specified mission in mission screen 801 of FIG. 89. Accordingly, the user has achieved the mission and “passes” the game or test.

### Alternate Embodiments

In some embodiments, the concept of winning or losing may not be applicable, such as when the disclosed principles are applied as a training device, mathematical visualization devices, or simulation devices.

With respect to a training device (e.g., brain training device at a hospital, job skill screening at work, etc.), a doctor (or recruiter or other similar position) may give time to a patient (or a job applicant) to learn the behavior of the mechanic objects. Once the test begins, the doctor/recruiter may analyze the patient/applicant's ability to use the mechanics, their modification of mechanic behaviors, test progress, and time spent. In embodiments such as this, a “success” or “fail” may be more subjective and the result may vary based on the patient/applicant's observed memory ability, creativity, spatial perception ability, personal experience ability, and analytical ability or personality. The results may be observed and a report may be printed evaluating the performance.

With respect to a mathematical visualization device, after a mission screen is displayed, a real-time information screen may be displayed (e.g., information screen 40 of FIG. 88). A simulation device that utilizes the principles of the present disclosure can allow a user to manipulate mechanic objects as controllable objects to create computational geometry. The user may move a position of mechanic objects by other mechanics. A server may compute received values and convert the values into color, area, and/or position as a computational geometry form. The server would then display the result of the visual image or animation at the information screen 40. Embodiments of the present disclosure may enable a user with mathematics and/or design knowledge to create a result of computational geometry by a predictable situation of mechanic object manipulation. However, this can apply to ordinary users without professional knowledge and can allow them to create intentional or unintentional geometries. These embodiments can be applied in creativity trainings or creativity evaluations.

With respect to a simulation device, the disclosed principles may be utilized to predict behaviors of production processes such as raw material mix, dispatch sequences, parts assembly sequences, and schedules. Embodiments of the present disclosure can provide a user interface for simulation to predict motion and sequence in injection, extrusion, 3D printing, or parts assembly facilities in case of frequent changes to the final product or on-demand production based on limited raw material ingredients or properties. For example, this application could function as a plug-in or be provided through an API to CAD software, BIM design software, production software, or quality control software.

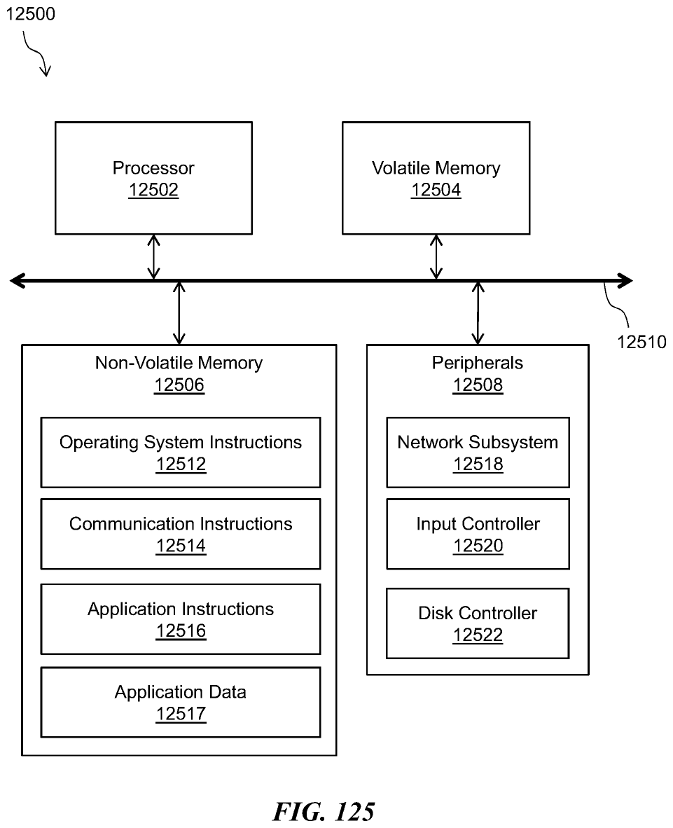

FIG. 125 is a diagram of an example server device 12500 that can be used within system 1000 of FIG. 1. Server device 12500 can implement various features and processes as described herein. Server device 12500 can be implemented on any electronic device that runs software applications derived from complied instructions, including without limitation personal computers, servers, smart phones, media players, electronic tablets, game consoles, email devices, etc. In some implementations, server device 12500 can include one or more processors 12502, volatile memory 12504, non-volatile memory 12506, and one or more peripherals 12508. These components can be interconnected by one or more computer buses 12510.

Processor(s) 12502 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 12510 can be any known internal or external bus technology, including but not limited to ISA, EISA, PCI, PCI Express, USB, Serial ATA, or FireWire. Volatile memory 12504 can include, for example, SDRAM. Processor 12502 can receive instructions and data from a read-only memory or a random access memory or both. Essential elements of a computer can include a processor for executing instructions and one or more memories for storing instructions and data.

Non-volatile memory 12506 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 12506 can store various computer instructions including operating system instructions 12512, communication instructions 12514, application instructions 12516, and application data 12517. Operating system instructions 12512 can include instructions for implementing an operating system (e.g., Mac OS®, Windows®, or Linux). The operating system can be multi-user, multiprocessing, multitasking, multithreading, real-time, and the like. Communication instructions 12514 can include network communications instructions, for example, software for implementing communication protocols, such as TCP/IP, HTTP, Ethernet, telephony, etc. Application instructions 12516 can include instructions for performing various processes to provide a game or test-like application, according to the systems and methods disclosed herein. Application data 12517 can include data corresponding to the aforementioned processes.

Peripherals 12508 can be included within server device 12500 or operatively coupled to communicate with server device 12500. Peripherals 12508 can include, for example, network subsystem 12518, input controller 12520, and disk controller 12522. Network subsystem 12518 can include, for example, an Ethernet of WiFi adapter. Input controller 12520 can be any known input device technology, including but not limited to a keyboard (including a virtual keyboard), mouse, track ball, and touch-sensitive pad or display. Disk controller 12522 can include one or more mass storage devices for storing data files; such devices include magnetic disks, such as internal hard disks and removable disks; magneto-optical disks; and optical disks.

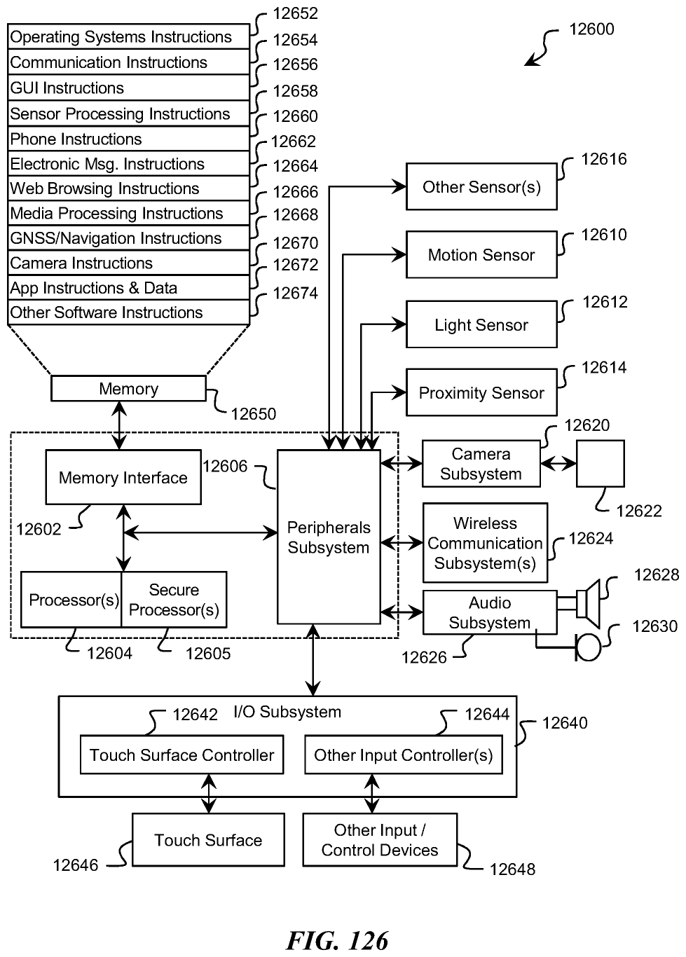

FIG. 126 is an example computing device 12600 that can be used within the system 1000 of FIG. 1, according to an embodiment of the present disclosure. In some embodiments, device 12600 can be any of devices 20-21 The illustrative user device 12600 can include a memory interface 12602, one or more data processors, image processors, central processing units 12604, and/or secure processing units 12605, and peripherals subsystem 12606. Memory interface 12602, one or more central processing units 12604 and/or secure processing units 12605, and/or peripherals subsystem 12606 can be separate components or can be integrated in one or more integrated circuits. The various components in user device 12600 can be coupled by one or more communication buses or signal lines.

Sensors, devices, and subsystems can be coupled to peripherals subsystem 12606 to facilitate multiple functionalities. For example, motion sensor 12610, light sensor 12612, and proximity sensor 12614 can be coupled to peripherals subsystem 12606 to facilitate orientation, lighting, and proximity functions. Other sensors 12616 can also be connected to peripherals subsystem 12606, such as a global navigation satellite system (GNSS) (e.g., GPS receiver), a temperature sensor, a biometric sensor, magnetometer, or other sensing device, to facilitate related functionalities.

Camera subsystem 12620 and optical sensor 12622, e.g., a charged coupled device (CCD) or a complementary metal-oxide semiconductor (CMOS) optical sensor, can be utilized to facilitate camera functions, such as recording photographs and video clips. Camera subsystem 12620 and optical sensor 12622 can be used to collect images of a user to be used during authentication of a user, e.g., by performing facial recognition analysis.

Communication functions can be facilitated through one or more wired and/or wireless communication subsystems 12624, which can include radio frequency receivers and transmitters and/or optical (e.g., infrared) receivers and transmitters. For example, the Bluetooth (e.g., Bluetooth low energy (BTLE)) and/or WiFi communications described herein can be handled by wireless communication subsystems 12624. The specific design and implementation of communication subsystems 12624 can depend on the communication network(s) over which the user device 12600 is intended to operate. For example, user device 12600 can include communication subsystems 12624 designed to operate over a GSM network, a GPRS network, an EDGE network, a WiFi or WiMax network, and a Bluetooth™ network. For example, wireless communication subsystems 12624 can include hosting protocols such that device 12600 can be configured as a base station for other wireless devices and/or to provide a WiFi service.

Audio subsystem 12626 can be coupled to speaker 12628 and microphone 12630 to facilitate voice-enabled functions, such as speaker recognition, voice replication, digital recording, and telephony functions. Audio subsystem 12626 can be configured to facilitate processing voice commands, voice-printing, and voice authentication, for example.

I/O subsystem 12640 can include a touch-surface controller 12642 and/or other input controller(s) 12644. Touch-surface controller 12642 can be coupled to a touch-surface 12646. Touch-surface 12646 and touch-surface controller 12642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 12646.

The other input controller(s) 12644 can be coupled to other input/control devices 12648, such as one or more buttons, rocker switches, thumb-wheel, infrared port, USB port, and/or a pointer device such as a stylus. The one or more buttons (not shown) can include an up/down button for volume control of speaker 12628 and/or microphone 12630.

In some implementations, a pressing of the button for a first duration can disengage a lock of touch-surface 12646; and a pressing of the button for a second duration that is longer than the first duration can turn power to user device 12600 on or off. Pressing the button for a third duration can activate a voice control, or voice command, module that enables the user to speak commands into microphone 12630 to cause the device to execute the spoken command. The user can customize a functionality of one or more of the buttons. Touch-surface 12646 can, for example, also be used to implement virtual or soft buttons and/or a keyboard.

In some implementations, user device 12600 can present recorded audio and/or video files, such as MP3, AAC, and MPEG files. In some implementations, user device 12600 can include the functionality of an MP3 player, such as an iPod™. User device 12600 can, therefore, include a 36-pin connector and/or 8-pin connector that is compatible with the iPod. Other input/output and control devices can also be used.

Memory interface 12602 can be coupled to memory 12650. Memory 12650 can include high-speed random access memory and/or non-volatile memory, such as one or more magnetic disk storage devices, one or more optical storage devices, and/or flash memory (e.g., NAND, NOR). Memory 12650 can store an operating system 12652, such as Darwin, RTXC, LINUX, UNIX, OS X, Windows, or an embedded operating system such as VxWorks.

Operating system 12652 can include instructions for handling basic system services and for performing hardware dependent tasks. In some implementations, operating system 12652 can be a kernel (e.g., UNIX kernel). In some implementations, operating system 12652 can include instructions for performing voice authentication.

Memory 12650 can also store communication instructions 12654 to facilitate communicating with one or more additional devices, one or more computers and/or one or more servers. Memory 12650 can include graphical user interface instructions 12656 to facilitate graphic user interface processing; sensor processing instructions 12658 to facilitate sensor-related processing and functions; phone instructions 12660 to facilitate phone-related processes and functions; electronic messaging instructions 12662 to facilitate electronic messaging-related process and functions; web browsing instructions 12664 to facilitate web browsing-related processes and functions; media processing instructions 12666 to facilitate media processing-related functions and processes; GNSS/Navigation instructions 12668 to facilitate GNSS and navigation-related processes and instructions; and/or camera instructions 12670 to facilitate camera-related processes and functions.

Memory 12650 can store application (or “app”) instructions and data 12672, such as instructions for the apps described above in the context of FIGS. 1-124. Memory 12650 can also store other software instructions 12674 for various other software applications in place on device 12600.

Note that the use of musical icons (e.g., eighth notes, quarter notes, and half notes) to differentiate between the various types of mechanic objects as done herein is not limiting and that a variety of different visual icons, graphics, or images can also be used.

In some embodiments, the server can also be configured to deliver data and data visualization tools to users via a secure request-based application programming interface (API). For example, users (e.g., network or utility management personnel) may wish to examine measurements in depth. The server can provide a range of data analysis and presentation features via a secure web portal. For example, the server can provide asset defect signature recognition, asset-failure risk estimation, pattern recognition, data visualizations, and a network map-based user interface. In some embodiments, alerts can be generated by the server if signal analysis of defect HF signals indicates certain thresholds have been exceeded.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

Although the disclosed subject matter has been described and illustrated in the foregoing illustrative embodiments, it is understood that the present disclosure has been made only by way of example, and that numerous changes in the details of implementation of the disclosed subject matter may be made without departing from the spirit and scope of the disclosed subject matter.

1. A method for providing a game or test application comprising:
causing a workplace to be displayed on an interface, the workplace comprising a plurality of field objects and a plurality of mechanic objects, wherein each of the mechanic objects is positioned within a field object;
causing a plurality of controllable objects to be displayed on the interface;
receiving a command to move one of the controllable objects to a position that overlays at least a portion of the plurality of field objects;
converting the overlaid portion of the plurality of field objects to an active region;
identifying a mechanic object contained within the active region; and
in response to identifying the mechanic object contained within the active region, running a mechanic object behavior on the mechanic object within the active region.

2. The method of claim 1 comprising, prior to causing the workplace to be displayed on the interface, causing a mission screen to be displayed on the interface, the mission screen indicating a mechanic object goal.

3. The method of claim 1 comprising indicating a quantity available for user manipulation associated with each of the plurality of controllable objects.

4. The method of claim 1, wherein running the mechanic object behavior comprises causing the mechanic object within the active region to move horizontally within the active region.

5. The method of claim 4, wherein the mechanic object is a first mechanic object, comprising:
detecting that the first mechanic object collides with a second mechanic object;
determining that the second mechanic object moved vertically prior to the collision; and
in response to detecting the collision, removing the second mechanic object from the interface.

6. The method of claim 4, wherein the mechanic object is a first mechanic object, comprising:
detecting that the first mechanic object collides with a second mechanic object;
determining that the second mechanic object has not moved prior to the collision; and
in response to detecting the collision, removing the first mechanic object from the interface.

7. The method of claim 1, wherein running the mechanic object behavior comprises causing the mechanic object within the active region to move vertically within the active region.

8. The method of claim 7, wherein the mechanic object is a first mechanic object, comprising:
detecting that the first mechanic object collides with a second mechanic object;
in response to detecting the collision, removing the first mechanic object from the interface; and
adjusting a value associated with the second mechanic object based on a value associated with the first mechanic object.

9. The method of claim 8 comprising displaying an indicator on the interface based on the value associated with the second mechanic object.

10. A system for providing a game or test application comprising:
a user device comprising a user interface; and
a server communicably coupled to the user device, the server being configured to:
cause a workplace to be displayed on the user interface, the workplace comprising a plurality of field objects and a plurality of mechanic objects, wherein each of the mechanic objects is positioned within a field object;
cause a plurality of controllable objects to be displayed on the user interface;
receive a command from the user device to move one of the controllable objects to a position that overlays at least a portion of the plurality of field objects;
convert the overlaid portion of the plurality of field objects to an active region;
identify a mechanic object contained within the active region; and
in response to identifying the mechanic object contained within the active region, run a mechanic object behavior on the mechanic object within the active region.

11. The system of claim 10, wherein the server is configured to, prior to causing the workplace to be displayed on the interface, cause a mission screen to be displayed on the interface, the mission screen indicating a mechanic object goal.

12. The system of claim 10, wherein the server is configured to cause an indicator to be displayed on the user interface, the indicator describing a quantity available for user manipulation associated with each of the plurality of controllable objects.

13. The system of claim 10, wherein running the mechanic object behavior comprises causing the mechanic object within the active region to move horizontally within the active region.

14. The system of claim 13, wherein the mechanic object is a first mechanic object, wherein the server is configured to:
detect that the first mechanic object collides with a second mechanic object;
determine that the second mechanic object moved vertically prior to the collision; and
in response to detecting the collision, remove the second mechanic object from the user interface.

15. The system of claim 13, wherein the mechanic object is a first mechanic object, wherein the server is configured to:
detect that the first mechanic object collides with a second mechanic object;
determine that the second mechanic object has not moved prior to the collision; and
in response to detecting the collision, remove the first mechanic object from the user interface.

16. The system of claim 10, wherein running the mechanic object behavior comprises causing the mechanic object within the active region to move vertically within the active region.

17. The system of claim 16, wherein the mechanic object is a first mechanic object, wherein the server is configured to:
detect that the first mechanic object collides with a second mechanic object;
in response to detecting the collision, remove the first mechanic object from the user interface; and
adjust a value associated with the second mechanic object based on a value associated with the first mechanic object.

18. The system of claim 17, wherein the server is configured to display an indicator on the user interface based on the value associated with the second mechanic object.

19. A method for providing a game or test application comprising:
receiving, from a server, instructions to display a workplace on a user interface, the workplace comprising a plurality of field objects and a plurality of mechanic objects, wherein each of the mechanic objects is positioned within a field object;
receiving, from the server, instructions to display a plurality of controllable objects on the user interface;
receiving, from a user, an indication to move one of the controllable objects to a position that overlays at least a portion of the plurality of field objects;
transmitting the indication to the server;
receiving, from the server, instructions to convert the overlaid portion of the plurality of field objects to an active region;
identifying a mechanic object contained within the active region; and
in response to identifying the mechanic object contained within the active region, receiving, from the server, instructions to run a mechanic object behavior on the mechanic object within the active region, wherein the mechanic object behavior comprises at least one of:
moving the mechanic object within the active vertically within the active region; or
moving the mechanic object within the active region horizontally within the active region.

20. The method of claim 19 comprising:
detecting a collision between two or more mechanic objects;
in response to detecting the collision, transmitting an indication of the collision to the server;
receiving an adjustment of a value associated with one of the two or more mechanic objects; and
displaying the adjustment on the user interface.
